(19) United States
(12) Patent Application Publication
(10) Pub. No.: US 2001/0037276 A1
(43) Pub. Date: Nov. 1, 2001

(54) System and methods for group retirement plan administration

(76) Inventors: William J. Kelly, Ankeny, IA (US); Stacie J. Franklin, West Des Moines, IA (US); Susie Thomann, Urbandale, IA (US); Angela M. Ellis, Norwalk, IA (US); Eric W. Hays, Urbandale, IA (US); Patricia M. Kliegl, Johnston, IA (US)

Correspondence Address: ZARLEY MCKEE THOMTE VOORHEES & SEASE PLC, SUITE 3200, 801 GRAND AVENUE, DES MOINES, IA, 50309-2721, US

(21) Appl. No.: 09/824,329

(22) Filed: Apr. 2, 2001

Related U.S. Application Data
(60) Provisional application No. 60/195,185, filed on Apr. 7, 2000.

(51) Int. Cl. G06F 17/60

(52) U.S. Cl. 705/36

(57) ABSTRACT

The invention includes a method of providing group retirement plan administrative services to one or more sponsors, at least one sponsor having one or more participants enrolled in a retirement plan, the method comprising electronically receiving contribution information from a sponsor, automatically updating a provider database based on the contribution information received from a sponsor; electronically providing account information to at least one sponsor; and electronically providing account information to at least one participant. The invention further provides for electronically transferring electronic funds between at least one account associated with a sponsor and at least one account associated with a provider.

### BACKGROUND OF THE INVENTION

The present invention relates to a method and system of administrating retirement plans such as 401(k) plans, and in particular, relates to a web-based method and system.

The explosion of employer-sponsored retirement savings plans carries with it a high administrative burden. This burden falls on both the company underwriting and/or administrating the plan, as well as the plan sponsor, usually an employer.

Take, for example, 401(k) plans. Information about plan participants (often employees) must be compiled and transferred by the plan sponsor (often an employer) to the plan provider that administers the plan. Thereafter, on an on-going basis, instructions, changes, and money must pass between the plan sponsor and the plan provider in order to operate the plan.

A conventional way of performing these tasks is for the plan sponsor to document the needed information to initialize the plan. This documentation is sent to the plan provider. The plan provider has staff to enter the information into its in-house computer system for processing. Thereafter, sponsors periodically fill out what are called “list bills” (sent from the plan provider), instructing the plan provider as to individual participants' choices regarding the plan (e.g. contribution amounts, investment options, etc.), changing or updating information, or otherwise providing the needed on-going data to effectuate plan participant choices regarding the plan. With the list bill, the plan sponsor typically sends one or more checks correlated to the contributions from participants and/or the plan sponsor.

As can be appreciated, the plan provider must expend considerable resources to handle and process the information and funds. The list bills and checks must be received and properly handled. Information, retrieved and documented once by the plan sponsor, must now be re-entered (sometimes manually) into the plan provider's computer system.

An additional factor has significance. Many plans allow the purchase of financial securities such as stocks, bonds, etc. By law, the plan provider must buy or sell the securities instructed by the list bill the day they receive the instructions or, make up any difference between the price of the security on the day of the order versus a higher price at any time thereafter. Thus, time is of the essence to process the list bills. A delay in entry, which delays the purchase or selling of securities, puts the plan provider at substantial risk of monetary loss.

Errors in data entry can also be costly. Data entry errors can occur on the list bill. The re-entry of information from the list bill by data entry personnel at the plan provider can also result in errors. These errors must either be rectified or compensated by the plan provider, or may delay the processing of the list bill order, again putting the plan provider at risk as discussed above. Such errors or delays may be individually relatively insignificant, but increase in significance given the number of transactions typically handled by retirement plan providers. The use of list bills requires cumbersome documenting of information and handling of funds by the plan sponsor. The plan provider has to re-handle the list bill information and funds.

Attempts have been made to address these problems. Some methods allow modem dial-in connectivity between the plan sponsor and the plan provider. This is helpful in allowing a plan sponsor to access information about the plan and send data to the plan provider. However, it requires distribution of specialized software to plan sponsor. It is cumbersome and costly to update and maintain the software. Therefore, update and maintenance of the software is usually done only periodically. Such a method also is essentially an electronic data transfer mechanism, but does not allow real time interaction with the plan provider.

Another method allows sponsors subscribing to the plan to access a front end of the plan provider's in-house system and essentially writes data from a plan sponsor to a file. The file can then be given to the in-house computer for retrieval and processing of the information in the file. However, there is no real time interactive ability allowing a plan sponsor to up-date or change data or information relative to the plan.

Therefore, there is a real need in the art for an improvement relative to the administration of retirement plans. It is therefore a principal object of the present invention to provide a method, apparatus, and system that improves over or solves the problems and deficiencies in the art.

Another object of the present invention is to provide a method, apparatus, and system that is capable of using a web-based, web-enabled front end for passing/sharing main frame data to/with a retirement plan provider.

Another object of the present invention is to provide a method, apparatus, and system that provides for a comprehensive, interactive front end for providing record keeping and other service to Group Retirement Plan Sponsors.

Another object of the present invention is to provide a method, apparatus, and system for a comprehensive, interactive front end for providing record keeping and other services to group retirement plan participants.

A still further object of the present invention is to provide a method, apparatus, and system for an improved way to handle both money and data relating to retirement plans.

Another object of the present invention is to provide a method, apparatus, and system for the administration of retirement plans that reduces data errors.

Yet another object of the present invention is to provide a method, apparatus, and system for the administration of retirement plans that reduces the time between receipt of a request and implementation of the request.

A further object of the present invention is to provide a method, apparatus, and system for administration of retirement plans that can automatically identify bad data.

Another object of the present invention is to provide a method, apparatus, and system for administration of retirement plans that is accessible at all times.

Yet another object of the present invention is to provide a method, apparatus, and system for administration of retirement plans that can be immediately updated.

Another object of the present invention is to provide a method, apparatus, and system for administration of retirement plans that allows interactive editing of information.

Yet another object of the present invention is to provide a method, apparatus, and system for administration of retirement plans that facilitates electronic fund transfers.

A further object of the present invention is to provide a method, apparatus, and system for administration of retirement plans that allows two-way communication between plan sponsors and the plan provider's in-house databases and application programs, and two-way communication between participants and the plan provider's in-house databases and applications.

A still further object of the present invention is to provide a method, apparatus, and system for administration of retirement plans that allows plan participants to view data regarding their involvement in the plan.

Another object of the present invention is to provide a method, apparatus, and system for administration of retirement plans that is customizable for each plan sponsor.

Yet another object of the present invention is to provide a method, apparatus, and system for administration of retirement plans that is flexible, allowing, for example, direct entry of data or entry from up-loading a file.

A further object of the present invention is to provide a method, apparatus, and system for administration of retirement plans that provides plan sponsors with quick, easy access to plan information, provisions, rules, and statistics.

A still further object of the present invention is to provide a method, apparatus, and system for administration of retirement plans that provides plan sponsors with secure, interactive two-way communication with a plan provider.

These and other objects, features, and advantages of the present invention will become more apparent with reference to the accompanying specification.

### SUMMARY OF THE INVENTION

One aspect of the present invention relates to a retirement plan administration method and system. The invention allows both retirement plan participants and retirement plan sponsors to electronically communicate with a retirement plan provider. The communication can occur through a web-based and web enabled front end for linking to a plan provider database. The invention presents an interface for retirement plan sponsors and retirement plan participants to exchange data with the plan provider system. In addition, the system facilitates electronic funds transfers. The system saves time and reduces errors associated with retirement plan administration.

Another aspect of the invention provides for different types of information associated with a retirement plan to flow between a plan provider and a plan sponsor and between a plan provider and a plan participant. The invention may also allow for a plan provider database to be automatically updated based on information received from a plan sponsor or a plan participant. The invention permits providers to electronically send contribution information directly to the plan provider and facilitates electronic funds transfer of contributions. The invention provides for account information to be sent to sponsors and to participants. The account information can be account summary information or detailed account information.

Another aspect of the present invention facilitates additional online reporting of value to plan sponsors. This information includes compliance tests such as may be needed to ensure that the plan sponsor's plan complies with applicable governmental rules.

Yet another aspect of the present invention provides for a number of interactions between the plan provider and participants in the plan. The present invention permits participants to electronically reallocate investments between investments in a retirement plan, including changing investment direction and rebalancing the investments made in a retirement plan.

These and other options of the present invention provide information to be exchanged between a plan participant and a plan provider and between a plan sponsor and a plan provider in order to effectuate a method and system for group retirement plan administration.

### BRIEF DESCRIPTION OF THE DRAWINGS

FIG. 1 is a diagram showing the information flow of the present invention between a plan participant in a group retirement plan, a plan sponsor of the group retirement plan, and the plan provider of the group retirement plan.

FIG. 2 is an illustration of a home page associated with a web site provided by a group retirement plan provider and accessible to group retirement plan sponsors and plan participants.

FIG. 3 is an illustration of a plan sponsor log-in web page.

FIG. 4 is an illustration of a plan sponsor services selection web page.

FIG. 5 is an illustration showing an information exchange web page accessible to a plan sponsor.

FIG. 6 is an illustration showing a send contribution web page accessible to a plan sponsor that permits a plan sponsor to select the type of contributions to send.

FIG. 7 is an illustration showing a send contributions web page accessible to a plan sponsor.

FIG. 8 is an illustration showing a final approval of contributions to send web page accessible to a plan sponsor.

FIG. 9 is an illustration of a file import of contributions to send web page accessible to a plan sponsor.

FIG. 10 is an illustration of a compliance test selection web page accessible to a plan sponsor.

FIG. 11 is an illustration of a compliance web page accessible to a plan sponsor.

FIG. 12 is an illustration of an electronic funds transfer web page accessible to a plan sponsor.

FIG. 13 is an illustration of an activity ledger web page accessible to a plan sponsor.

FIG. 14 is an illustration of an executive summary options web page accessible to a plan sponsor.

FIG. 15 is an illustration of an executive summary setup web page accessible to a plan sponsor.

FIGS. 16A-16C are diagrams of an investment information web page accessible to a plan sponsor.

FIG. 17 is an illustration of an investment by risk web page accessible to a plan sponsor.

FIG. 18 is an illustration of an investment by age web page accessible to a plan sponsor.

FIG. 19 is an illustration of an investment by salary web page accessible to a plan sponsor.

FIG. 20 is an illustration of participation summary web page accessible to a plan sponsor.

FIG. 21 is an illustration of a participation by age and salary web page accessible to a plan sponsor.

FIG. 22 is an illustration of an interactive telephone usage summary web page accessible to a plan sponsor.

FIG. 23 is an illustration of an interactive telephone usage web page accessible to a plan sponsor.

FIG. 24 is an illustration of a plan participant login web page.

FIG. 25 is an illustration of a retirement services personal summary web page accessible to a plan participant.

FIGS. 26A and 26B are diagrams of a retirement services plan details web page accessible to a plan participant.

FIGS. 27A and 27B are diagrams of a change investment direction web page accessible to a plan participant.

FIG. 28 is an illustration of a transfer existing money web page accessible to a plan participant.

FIG. 29 is an illustration of a rebalance money web page accessible to a plan participant.

FIG. 30 is a block diagram of the system of the present invention.

### DETAILED DESCRIPTION OF EXEMPLARY EMBODIMENTS

The present invention relates to the information flow and information exchange between the parties in a retirement planning context. The parties include one or more participants, one or more sponsors, and a plan provider. Each participant may be an employee of a plan sponsor. The plan sponsor (often an employer) provides the retirement plan through a plan provider. The plan provider would generally administration services to the plan. Typically, the plan provider would administration services for retirement plans for a number of different participants associated with a number of different sponsors. Retirement planning can include any number of retirement plans, both qualified and non-qualified retirement plans.

The following detailed description is directed to a method and system for administering 401(k) type group retirement plans. The present invention is not, in anyway limited to this particular type of group retirement plan.

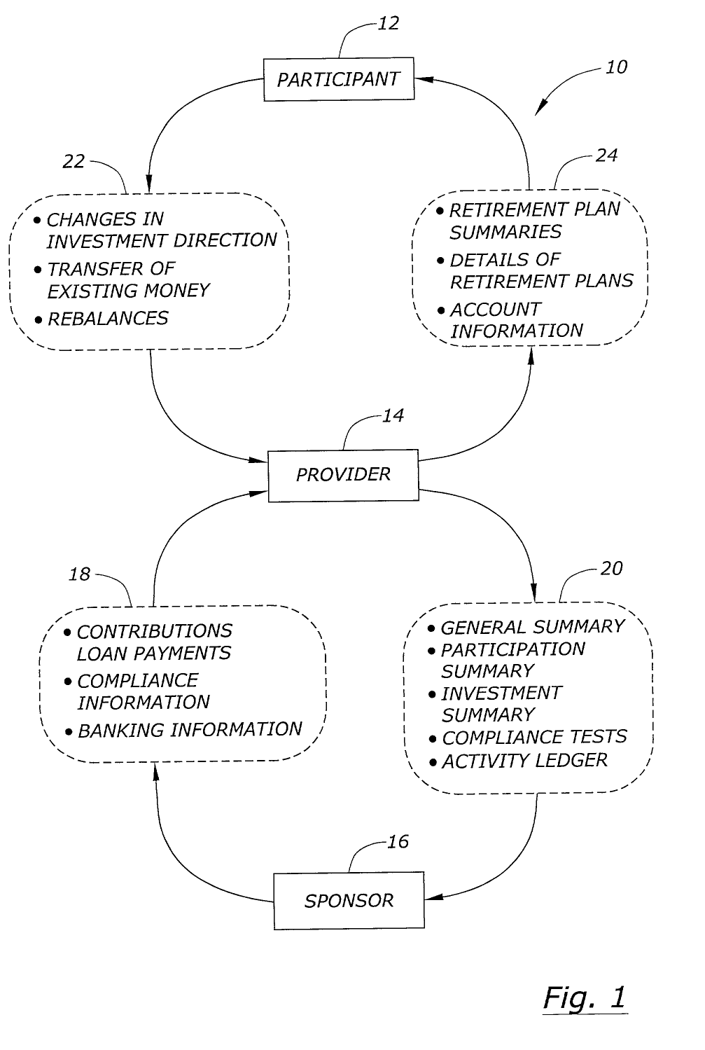

FIG. 1 best shows the relationships between the plan participant, the plan provider, and the plan sponsor and the information flow between each entity. In FIG. 1, information flow 10 involves a plan participant 12, a plan provider 14, and a plan sponsor 16. Although only one of each entity is shown, it is to be appreciated that a single provider may provide retirement plan related services to any number of sponsors. Each sponsor may have any number of participants as well. Thus the plan provider 14 may actually be communicating with a number of sponsors 16 and a number of participants 12. Similarly, each sponsor 16 may have any number of retirement plans.

The plan sponsor 16 exchanges information with the plan provider 14. The plan sponsor 16 transmits information concerning contributions made to retirement plans of the plan participants associated with the plan sponsor, loan payments made to a retirement account by participants associated with the plan sponsor, compliance information associated with the plan sponsor, and banking information associated with the plan sponsor. The present invention contemplates that other information associated with the plan sponsor may be transferred to the plan provider. Examples of other information will later be described in greater detail.

The plan provider 14 also transfers information to sponsor 16. This information 20 can include general summaries of the retirement plans associated with participants of the plan sponsor, participation summaries, investment summaries, the results of compliance tests, and an activity ledger.

The plan provider 14 also exchanges information with the plan participant 12. The plan participant 12 may transfer information 22 to the plan provider 14. The information 22 can include changes in investment direction, the transfer of existing money, and rebalancing of investment allocation.

In addition, the plan provider 14 may transfer information 24 to the plan participant 12. This information can include retirement plan summaries, details of retirement plans, and account information.

The information exchange between the plan provider 14 and sponsor 16 and between the plan provider 14 and participant 12 may occur over the Internet or other network. The information may be presented to and retrieved by the plan provider 14 through use of a world wide web based interface. As can be appreciated, the use of this type of network and this type of interface provides a convenient method for large numbers of people to access this information. In addition, participants and sponsors would normally have access to the Internet and would not accrue any additional costs when a web based system is implemented.

Thus, an Internet site may be associated with the invention. An example of an exemplary world wide web site follows. It is to be appreciated that the present invention is in no way limited to the particular description set forth. The embodiment described is merely one way of practicing the invention. Various design decisions concerning the structure of the web site and the selection of particular types of design elements may be made as may be consistent with the spirit of the invention and changing technologies. Thus there are many different manners in which the present invention can be implemented in order to reproduce the functionality of the invention.

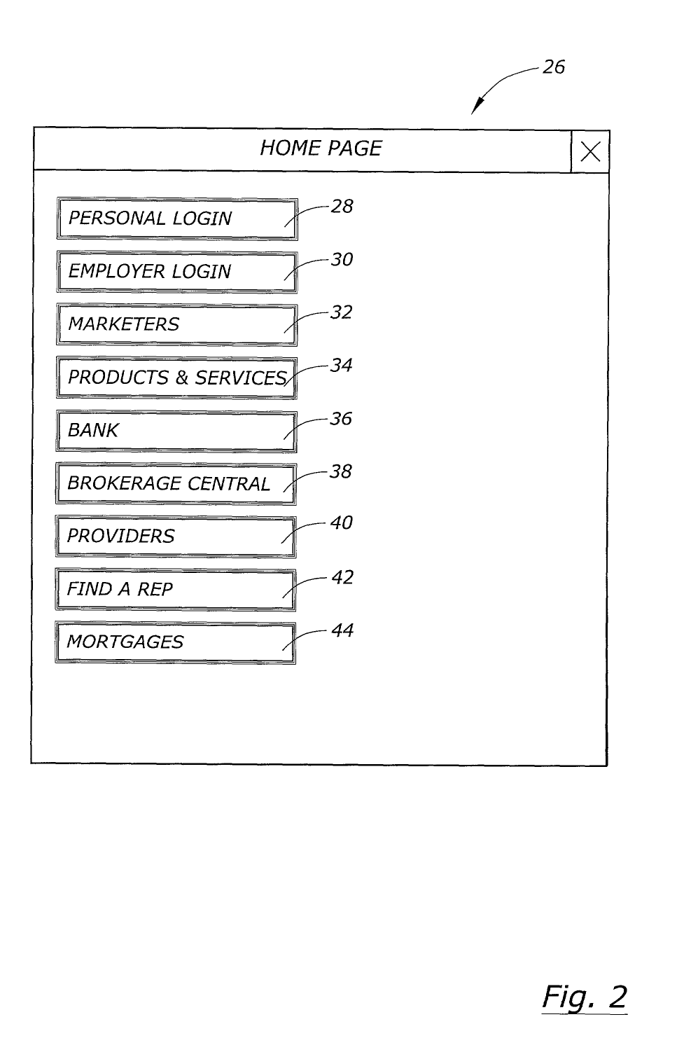

FIG. 2 shows a home page 26. The home page 26 has a number of links associated with it. These links provide visitors to the home page 26 with access to different aspects of the invention as well as other options. These links may include a personal log-in 28 through which a plan participant may personally log into the web site in order to exchange information. Similarly, the employer log-in link 30 provides sponsors with the ability to access that portion of the web site that permits the plan sponsor to exchange information with the plan provider. The present invention contemplates numerous other links to related services and other information such as a link to marketers 32, a link to products and services 34, a link to a bank 36, a link to a brokerage center 38, a link to providers 40, a link associated with finding a representative 42, and a link associated with mortgages 44. These additional links allow participants and sponsors the opportunity to interact with the retirement plan provider for other business purposes.

The web site of the present invention is preferably secure. Security can be added through a number of different methods as are known in the art. For example, security can be added through implementation of the secure sockets layer (SSL) protocol or other protocols that implement public/private keys, digital certificates, and other security measures aimed at providing authentication. Similarly, other security protocols or measures that are otherwise known in the art may be used. The plan sponsors and participants must log in to the system by entering an identifier, and a personal identification number (PIN) or other means of identification. The present invention is not in anyway limited to the type of security used. The present invention merely appreciates that the information exchanged may be considered confidential and private by both sponsors and participants.

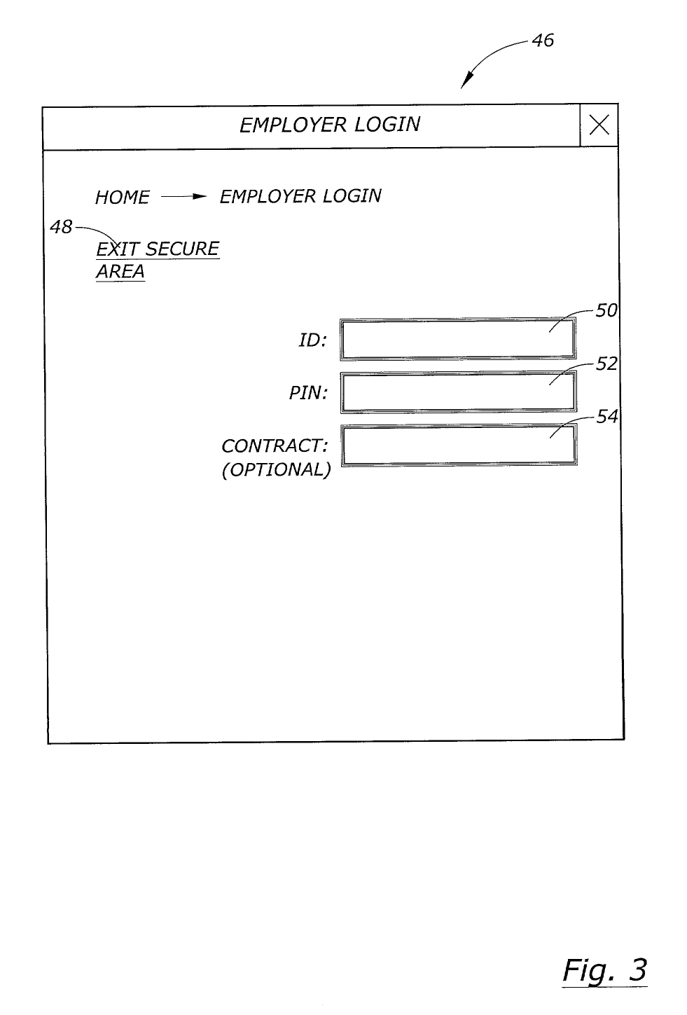

FIG. 3 shows a display for a plan sponsor log-in 46. A visitor can access the plan sponsor log-in page 46 and then must either log-in or exit the secure area through link 48. In order to log-in, a plan sponsor must enter the ID 50, a PIN 52, and optionally a contract number 54. The present invention contemplates that other types and forms of security may be used such as may be known in the art or such as a particular environment or technology may suggest.

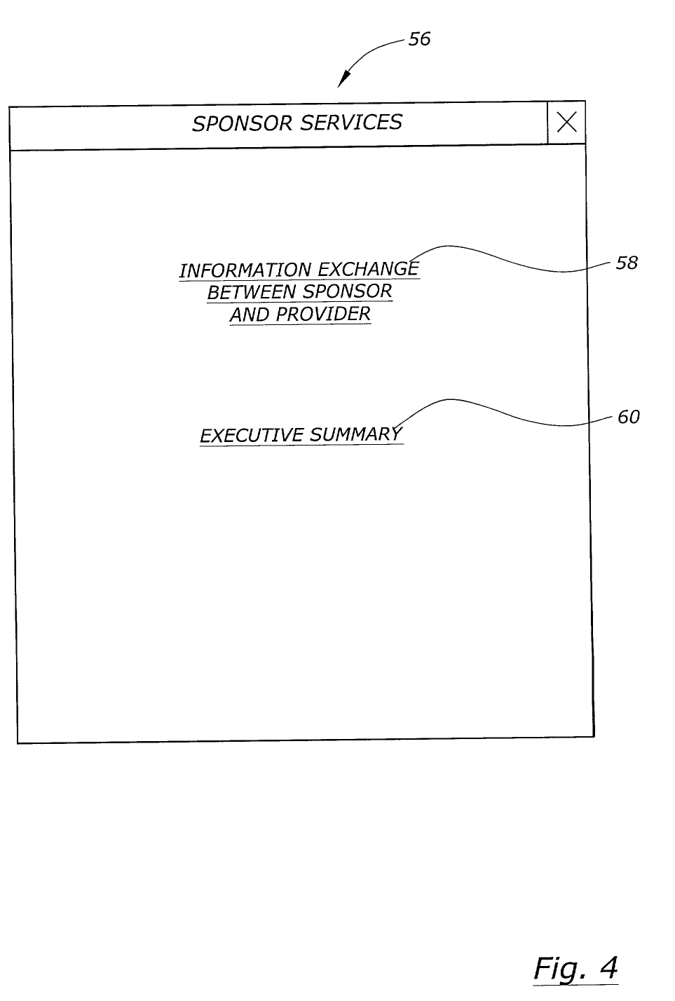

As shown in FIG. 4, once a plan sponsor successfully logs in to the system, the plan sponsor is given options such as presented on the plan sponsor services web page 56. For example, the plan sponsor may choose to follow a link associated with an information exchange between the plan sponsor and the plan provider 58 or the plan sponsor may elect to view a link associated with the executive summary 60.

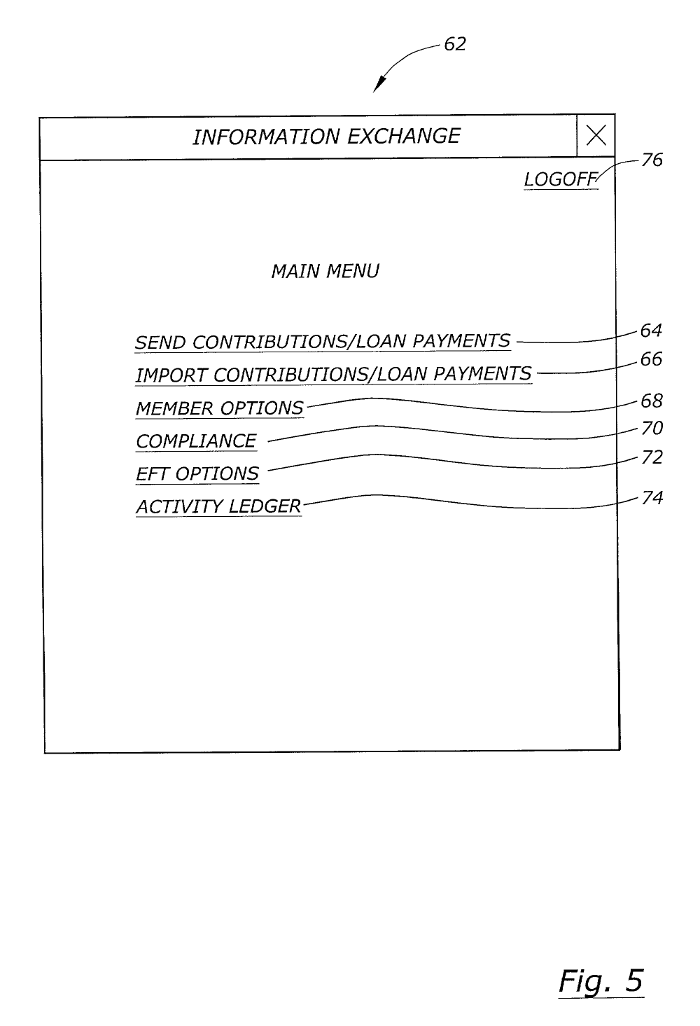

As shown in FIG. 5, once the plan sponsor elects to follow the information exchange link 58, the plan sponsor is presented with the information exchange main menu web page 62. This web page provides the plan sponsor with a number of different options related to information that can be exchanged between the plan sponsor and the plan provider. These options include following a send contributions/loan payments link 64, following an import contributions/loan payments link 66, following a member options link 68, following a compliance link 70, following an electronic funds transfer (EFT) link 72, and following an activity ledger link 74.

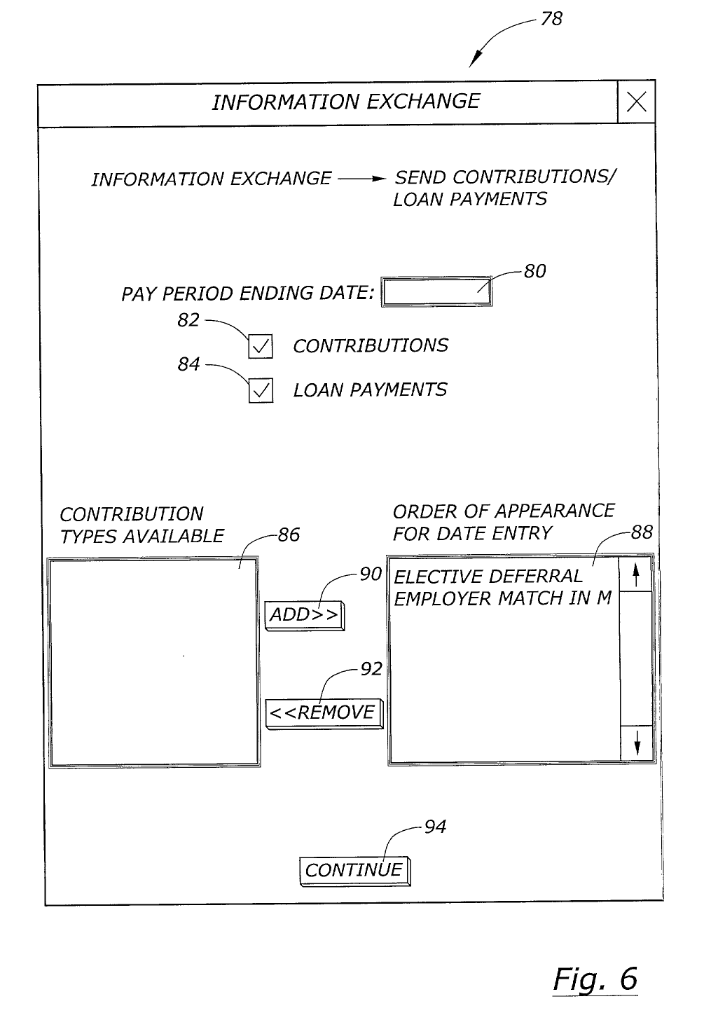

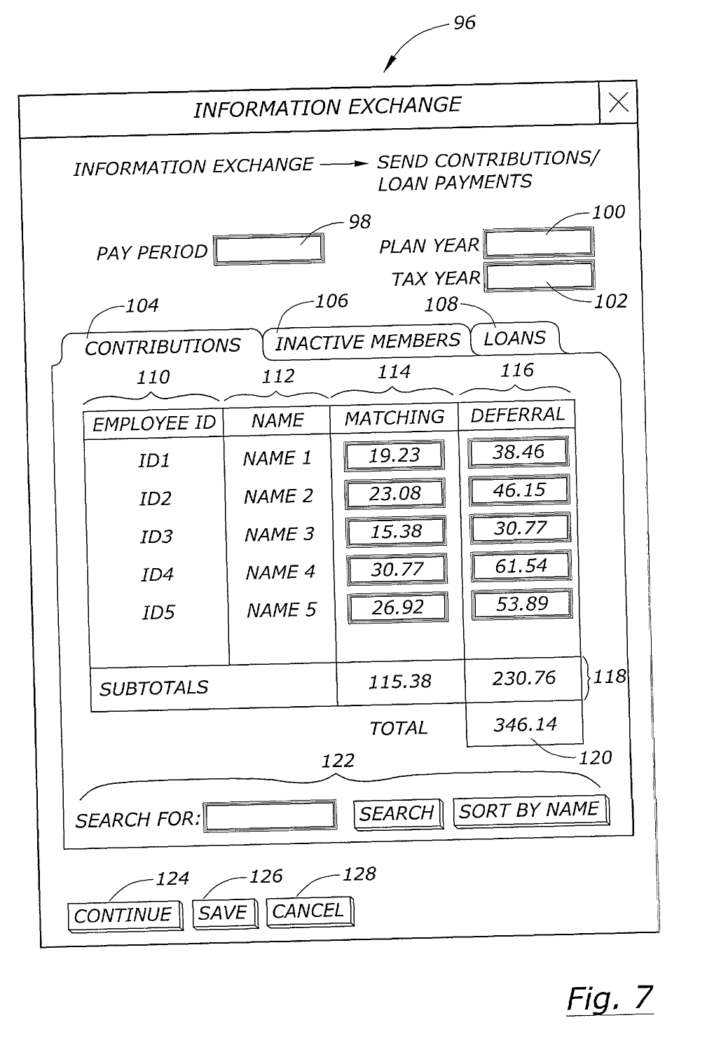

When the plan sponsor chooses to navigate to the send contributions/loan payments option, the plan sponsor is presented with the send contributions/loan payments web page of FIG. 6. In FIG. 6, the send contributions/loan payments page 78 is the first web page in a series of web pages that permit the plan sponsor to electronically send contributions and loan payments to the plan provider. In web page 78, the plan sponsor specifies a pay period ending date 80, and whether the information to be exchanged includes contributions 82 and/or loan payments 84. The plan sponsor may also set the types of contributions that will be sent. This may be formed by selecting different types of contributions from a first list box 86 and then selecting the add button 90 to move these types of contribution to the list box 88 containing the types of contributions/loan payments to send. One or more contribution types may be removed from the list box 88 by selecting a contribution type and then selecting the remove button 92. The contribution types can include an elective deferral which is a contribution made by a plan participant and then deducted by a plan sponsor from the plan participant's wages or otherwise electively deferred. Another example of the contribution type is an employer matching contribution in which an employer contributes an amount to the retirement plan of a plan participant. The present invention contemplates numerous types of contributions. Once the contribution types have been determined, the plan sponsor may select the continue button 94 to proceed to the web page shown on FIG. 7.

FIG. 7 displays another web page 96 associated with the plan sponsor sending contributions/loan payments to the plan provider. Information provided includes pay period 98, plan year 100, and tax year 102. Web page 96 also contains a tab control or other component or implementation of a tab-like display. A user can access the information associated with each tab. These tabs include information such as contributions 104, inactive members 106, loans 108, negative contributions (not shown), and forfeitures (not shown).

The contributions tab 104 contains an ID column 110 for displaying employee identification numbers which may be social security numbers. A name column 112 displays the names of employees who may be making contributions. A matching column 114 and a loans column 116, are used to display the matching contributions for an employee made by a plan sponsor and the contribution made (amount deferred) by the employee or participant. The plan sponsor may modify these amounts accordingly by inputting or changing values entered in the text boxes in the matching column and the deferred column. For example, the employer or sponsor could choose to contribute one half of the amount that the employee or participant elects to defer. A subtotal 18 for each type of contribution is shown and a total 120 for the combined amount of the contributions is also shown.

In addition, additional functionality is provided through search and sort functions 122 that allow a user to search for a particular employee or to sort employees. The search and sort functions are particularly useful where there are a large number of employees or participants associated with a single sponsor. Navigation buttons may also be used on web page 96. For example, a continue button 124 may be used to proceed to the next screen in a sequence of screens. In addition save button 126 allows the current information to be saved and cancel button 128 ensures that changes made are not saved.

Although the contents of other tabs are not shown, each tab contains other information that a plan sponsor would use in sending contributions, loan payments, and related information. For example, loan tab 108 can display the amount of loan payments and additional principal only payments for participants who have borrowed from their retirement plan.

Although tabs are used to group related information, the present invention is in no way limited to a particular manner of displaying information. The use of tabs is merely a convenient and user-friendly interface design decision.

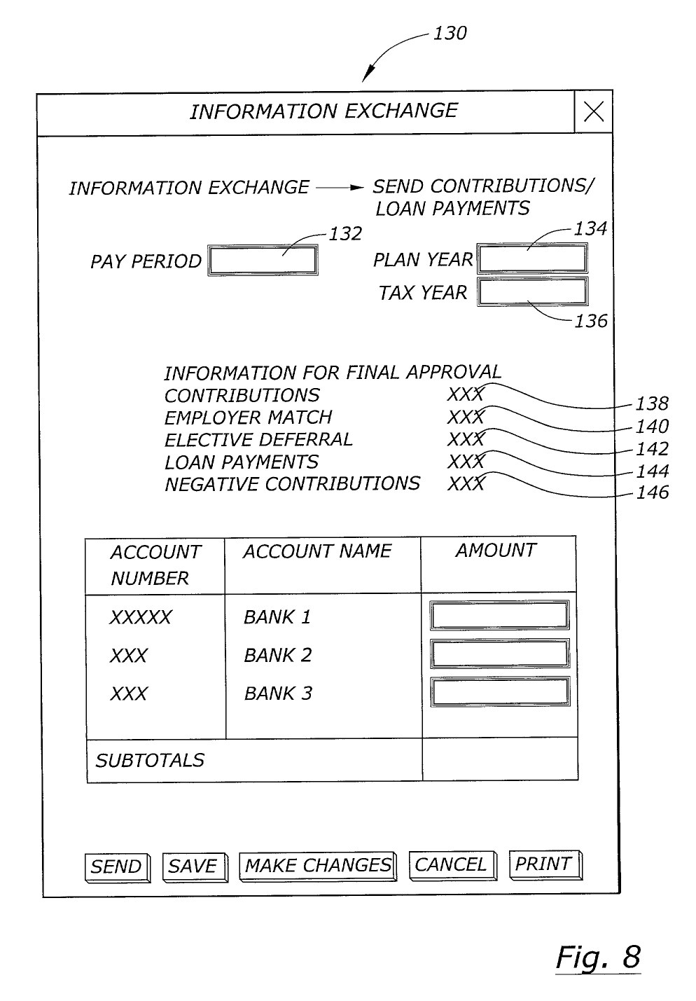

FIG. 8 illustrates a send contributions confirmation web page 130. The confirmation web page 130 displays the pay period 132, the plan year 134, and the tax year 136. For this particular pay period, information concerning the amounts of contributions 138, employer matching contributions 140, elective deferrals 142, loan payments 144, and negative contributions 146 are displayed. This provides a plan sponsor the opportunity to review the contribution information before making an electronic funds transfer that sends the contributions and loan payments from a bank account associated with the plan sponsor to a bank account associated with the plan provider. The present invention contemplates that the plan sponsor may have multiple bank accounts from which the contributions or loan payments may be transferred. The present invention permits the plan sponsor to divide a total contribution amount between multiple bank accounts. If the plan sponsor agrees with the contribution totals then the plan provider may transfer the corresponding amount through an electronic funds transfer request.

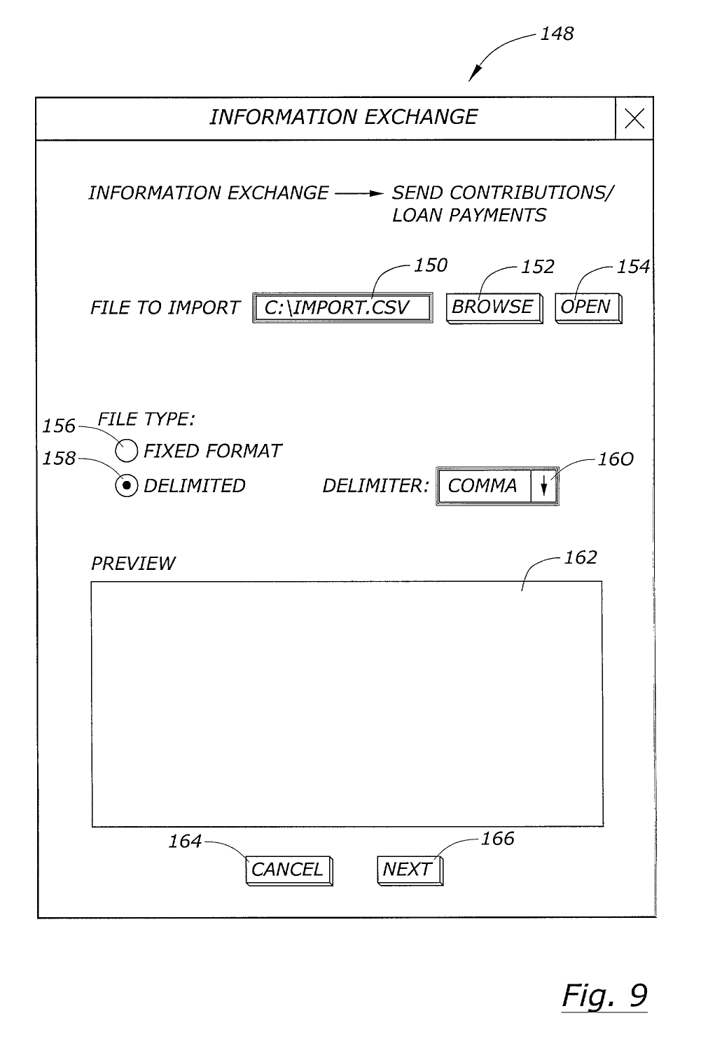

The present invention also contemplates that instead of requiring the plan sponsor to enter the contribution and loan payment amounts manually into the information exchange web site, the plan sponsor may also import a file containing the necessary information. For example, the plan sponsor's internal accounting software may be able to generate a file that contains all the required information. For example, the plan sponsor may use a spreadsheet application to conduct the plan sponsor's accounting. Spreadsheet applications and accounting applications often allow a user to save or export information to another file such as a comma separated value (csv) file or other such file such as may be known in the art. The present invention permits a plan sponsor to simply import a pre-existing file containing contribution and loan payment information. This simplifies the information exchange process for the plan sponsor as this information does not need to be manually re-entered into the information exchange web site. The plan sponsor need only save the required information in a delimited file and then import the file into the information exchange web site. Referring to FIG. 9, the plan sponsor need only select the file to the import through entering the file name in text box 150 or selecting a file through the use of browse button 152. Once the file is selected, the user can press the open button 154. The plan sponsor then may select the type of file that is being imported. For example, the plan sponsor can use a fixed format file associated with radio button 156 or a delimited format file associated with option button 158. If the file type is delimited, then the plan sponsor may use the drop-down list box 160 to select the particular delimiter that is used. Common delimiters include commas, semi-colons, spaces, and tabs.

The present invention also contemplates that the user may also specify text qualifiers such as double quotes or single quotes that may be used to set off data contained in the import file. In addition, the present invention contemplates that there may also be headers and/or footers contained in the import file so the plan sponsor may select the row to begin the import and the row to end the import at so that the header and footer information which is not desired, is not imported. To aid in the process of selecting the proper import parameters, a preview box 162 may also be used that contains the file data or the file data associated with a previously imported file. Once the import parameters are selected the plan sponsor can either select to cancel by selecting the cancel button 164 or may proceed with the import by selecting the next button 166. The data may then be verified prior to being imported. In addition, if any errors occur in the import process, the plan sponsor may be informed. The file format of the import file may also be saved so that in future imports, the plan sponsor need not adjust the file type information.

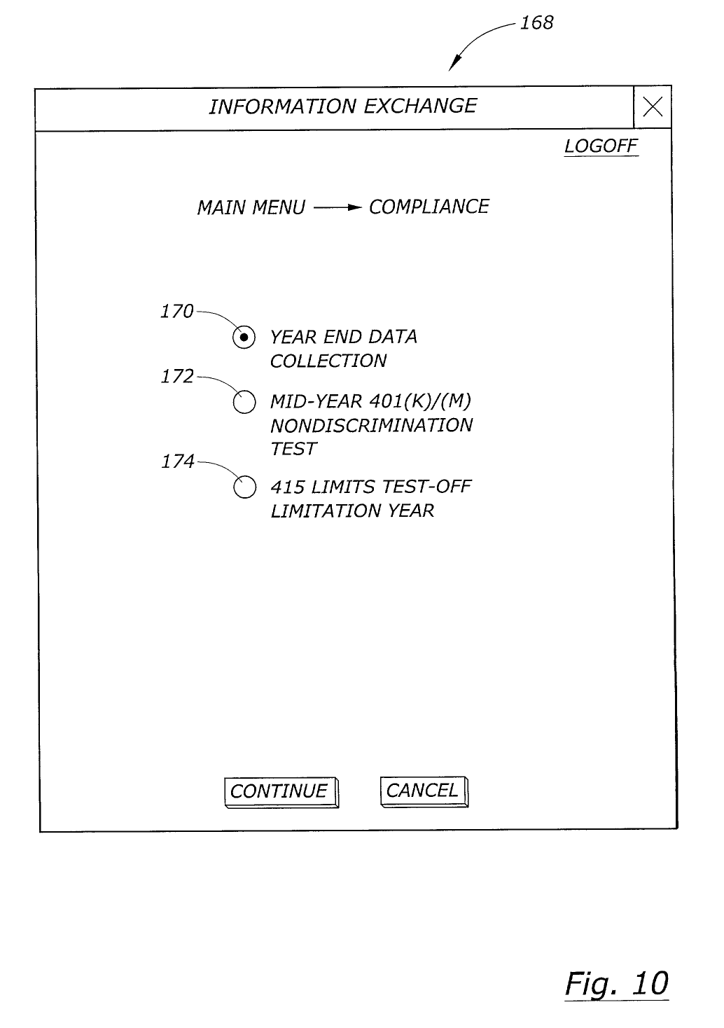

FIG. 10 shows a compliance selection web page 168. Using web page 168, a plan sponsor may select a type of compliance tests to perform. Compliance tests are used to determine whether a particular retirement plan meets certain government requirements. The present invention contemplates that numerous types of compliance tests and compliance filings may be used as required by a government, or the plan sponsor. Examples of three such compliance related tests include a plan year-end data collection that may be selected through associated option button 170, a mid-year 401(k)/(m) non-discrimination test that may be selected through associated option button 172, and a 415 limits test—off limitation year that may be selected through associated option button 174. The present invention contemplates that multiple tests may be performed at the same time. For example, in the case of a plan year-end data collection, tests such as a top-heavy test, a coverage test, a 401(k)/(m) non-discrimination test, and an IRS form 5500 annual report can all be performed.

A top-heavy test is a test to see if the retirement plan meets qualification requirements for a given plan year. A retirement plan is considered top-heavy when key employees hold more than a certain percentage (i.e. 60%) of the total retirement funds in their accounts. The significance of a top-heavy plan is that when a retirement plan is top-heavy, faster vesting requirements may apply. If a retirement plan is top-heavy, a minimum contribution may be due.

A coverage test may be performed to determine if the retirement plan meets minimum coverage rules associated with internal revenue code section 410(b). The test is used to ensure that a particular retirement plan does not discriminate in favor of highly compensated employees. The particular coverage test for a contribution plan may include a number of separate tests depending upon the particular retirement plan. These tests may involve testing for 401(k) provision for elective deferrals, testing for 401(m) provisions for matching contributions from sponsors and employee after-tax contributions, and testing for non-401(k)/(m) provisions for other employer contributions and qualified non-elective contributions. A 401(k)/(m) nondiscrimination test is also used to determine whether a plan discriminates in favor of highly compensated employees. In this type of test, the deferral and contribution percents for the highly compensated employees are examined. If highly compensated employees, deferral and contribution percents exceed those of the non-highly compensated employees by more than the limit allowed by the IRS, refunds may be necessary.

Compliance testing also includes preparation of certain reports such as the report required for IRS form 5500 annual return/report and schedules. The present invention permits compliance tests and reports to be provided for particular plan years and for particular definitions of compensation such as elective contributions, fringe benefit exclusions, other exclusions, exception 125 contributions, and plan compensation, and gross compensation.

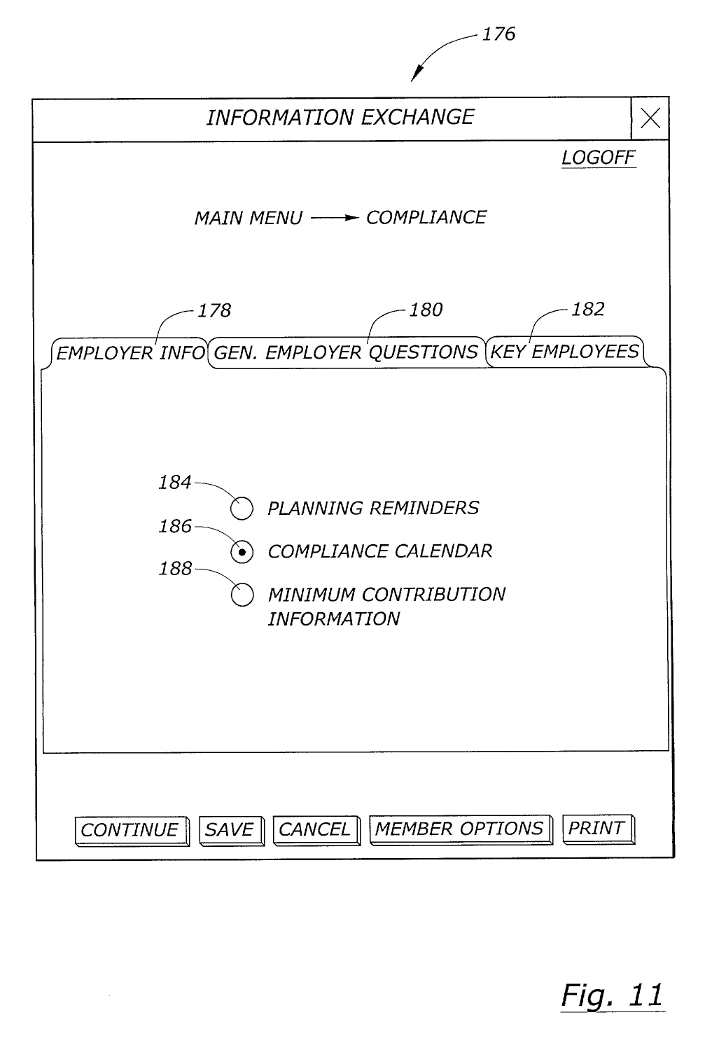

In order to perform compliance tests and reports, sponsors are allowed to review and modify information associated with the plan sponsor, plan participants, key employees of the plan sponsor, highly compensated employees of the plan sponsor, census information associated with the plan sponsor, compensation of participants, test information, and form information. This collection and display of information is shown in part in FIG. 11 that shows compliance information web page 176. On web page 176, there are a number of tabs with various information displayed on each tab. For example, an employer information tab 178 provides options for receiving additional information such as planning reminders associated with option button 184, a compliance calendar associated with option button 186, and minimum contribution information associated with option button 188. Planning reminders may provide information on important topics associated with the plan. A compliance calendar may show deadlines associated with the IRS, the plan sponsor or other deadlines. The minimum contribution information may provide additional information concerning why, when, and how to make minimum contributions. The other tabs provide related information needed for compliance testing and for forms. Although the particular selection of this information is no way limited by the present invention, common information that may be collected or required includes such information as business structure, controlled and affiliated service group information, additional plans, collectively bargained employees, pending items, retirement plan operation changes, compensation associated with highly compensated employees, compensation associated with key employees, census information, compensation associated with all employees, other contributions made by all employees, additional testing information, and additional information such as may be required by the Internal Revenue Service or other government agency, the plan provider, or other reasons.

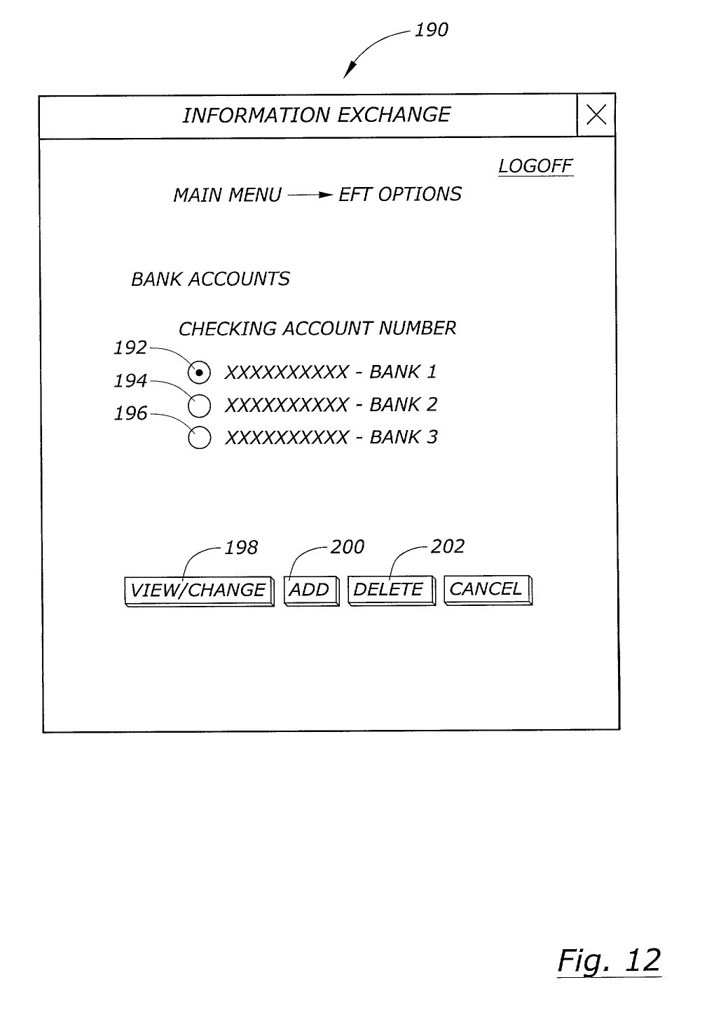

The present invention also provides for sponsors to add or change information associated with electronic funds transfers. FIG. 12 shows electronic funds transfer options web page 190. Web page 190 provides sponsors the opportunity to select which banking accounts are available for use for electronic funds transfers. For example, a plan sponsor may select a first bank account number associated with the first bank by selecting first account option button 192, a second bank account number associated with a second bank by selecting second account option button 194, or a third bank account associated with a third bank by selecting third account option button 196. The present invention permits sponsors to view or change bank account information by selecting the view/change button 198, to add new bank accounts by selecting add button 200, or to delete bank accounts by selecting the delete button 202. In this matter the present invention contemplates that a plan sponsor may have multiple bank accounts at multiple banks and they want to use any one or a combination of different bank accounts to make electronic funds transfers.

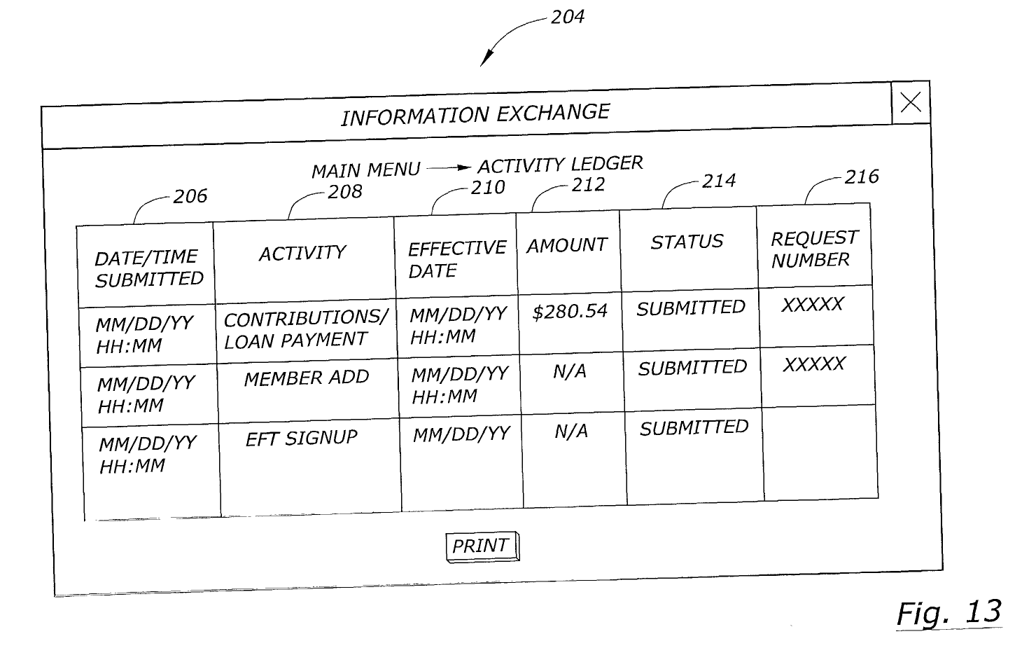

FIG. 13 displays an activity ledger web page 204. The activity ledger web page 204 permits the plan sponsor to review recent activities conducted by the plan sponsor on the information exchange web site. The activity ledger may contain a column date/time 206 containing the date and time associated with a particular activity. In addition, the description column 208 contains a description of the particular activity that a plan sponsor engaged in. The effective date/time Column 210 contains an effective date and time of the activity. A particular activity may be submitted on one date, however, the transaction may not be effective until a second date. The activity ledger also provides for an amount column 212 that shows the amount of money involved in the particular activity if applicable. The status column 214 allows a plan sponsor to review whether the particular activity has been performed or is pending and a request number 216 is associated with the submission for identification purposes if necessary. Thus a plan sponsor may view the activity ledger on activity ledger web page 204 for a summary of recent submissions made to the information exchange web site. Examples of activities include contributions and loan payments, adding additional participants, signing up for electronic funds transfer and other activities associated with a plan sponsor's use of the information exchange internet site.

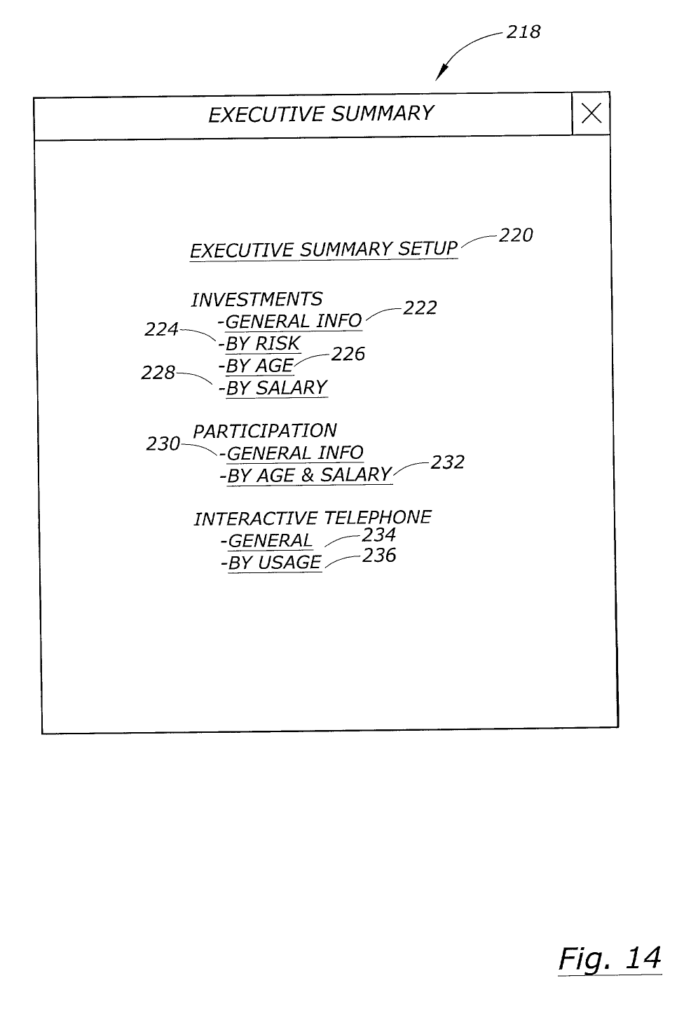

The present invention also permits a plan sponsor to view executive summary information such as is summarized in executive summary web page 218 in FIG. 14. The executive summary information consists of settings specifying how the information should be displayed. The settings may be modified through selection of the executive summary setup link 220. The executive summary information includes summarized investment information, including general information concerning investments which may be viewed by selecting the general information link 222, investment information summarized by risk which may be selected through selection of the by risk link 224, investment information summarized by age which may be viewed by selecting the by age link 226, investment information summarized by salary which may be viewed by selecting the by salary link 228. The executive summary information also includes summary information concerning participation in the group retirement plan. General information concerning participation may be viewed by selecting a general information link 230, participation information summarized by age and salary may be displayed by selecting the by age and salary link 232. Summary information may also include the summary of use of an interactive telephone service. The interactive telephone service may provide interactive voice response to requests from participants for retirement plan information. A general information link 234 provides general information concerning use of the interactive telephone services, and the by usage link 236 provides summary information of use of the interactive telephone service by particular usage.

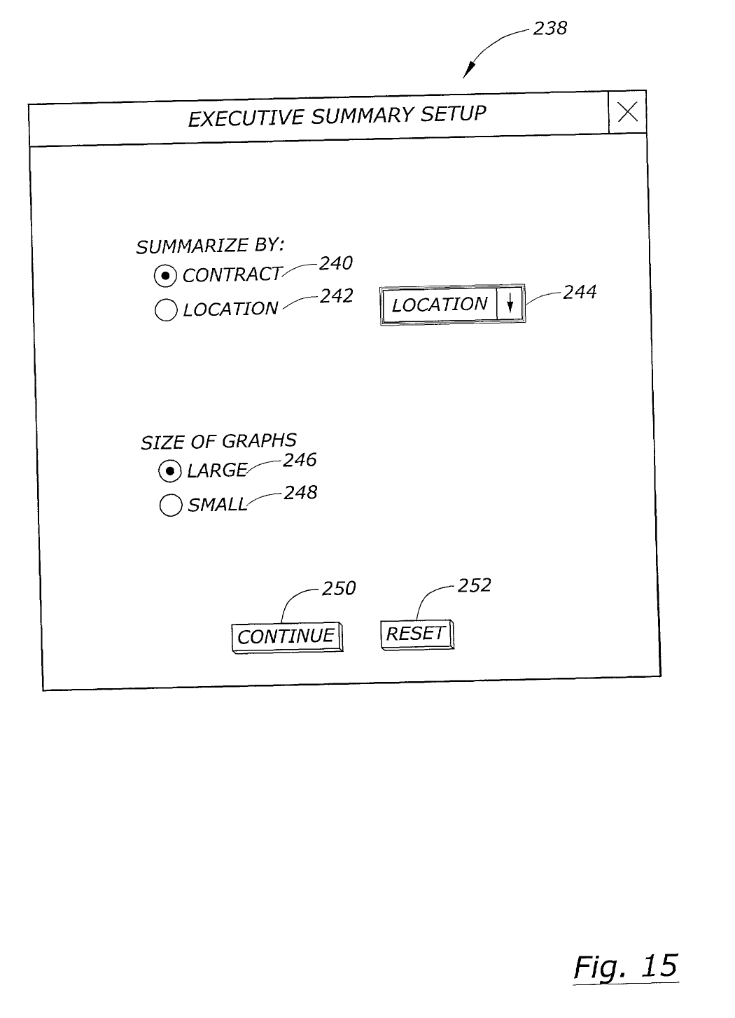

FIG. 15 displays the executive summary setup web page 238. This web page provides sponsors with the opportunity to select the format used to summarize or to display information. For example, group retirement plan information may be summarized by contract or location. Selection of the contract option button 240 allows a plan sponsor to select that group retirement plan information summarized by contract, and selection of the location option button 242 allows a plan sponsor to specify that the group retirement plan information should be summarized by location. When group retirement plan information is summarized by location, a plan sponsor may choose the particular location by selecting a location in the drop-down list box 244. Similarly, the plan sponsor may select attributes associated with the format or display of information. For example the plan sponsor may select the size of graphs to be used to summarize information. The plan sponsor may select the large option button 246 to specify that large graphs should be displayed and the plan sponsor may alternatively select the small option button 248 to specify that small summary graphs should be displayed.

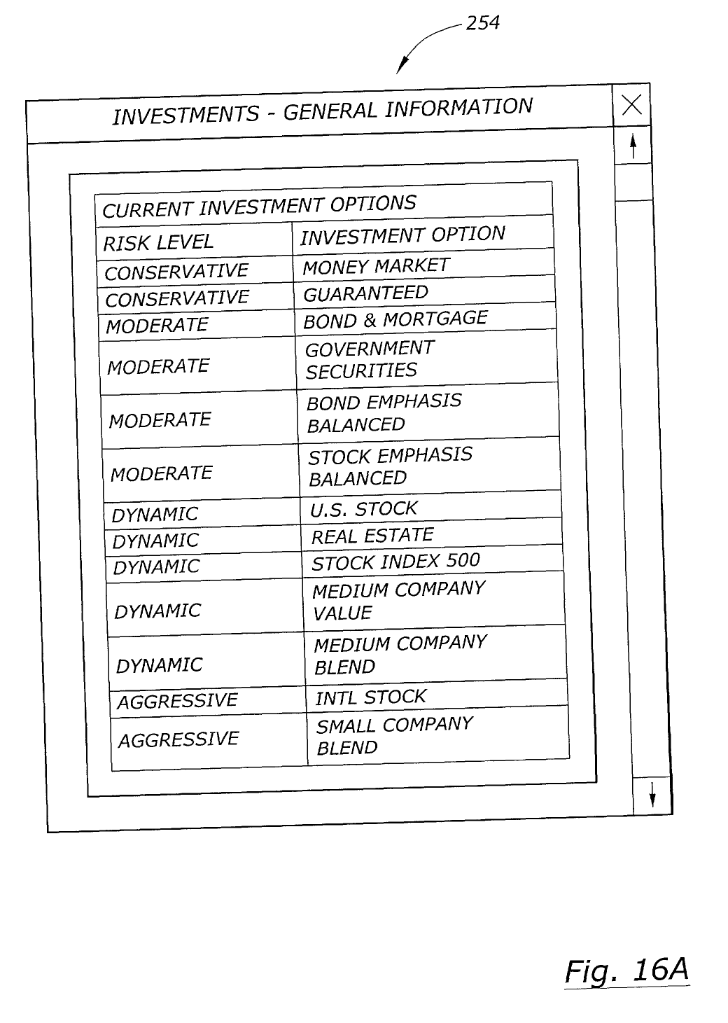

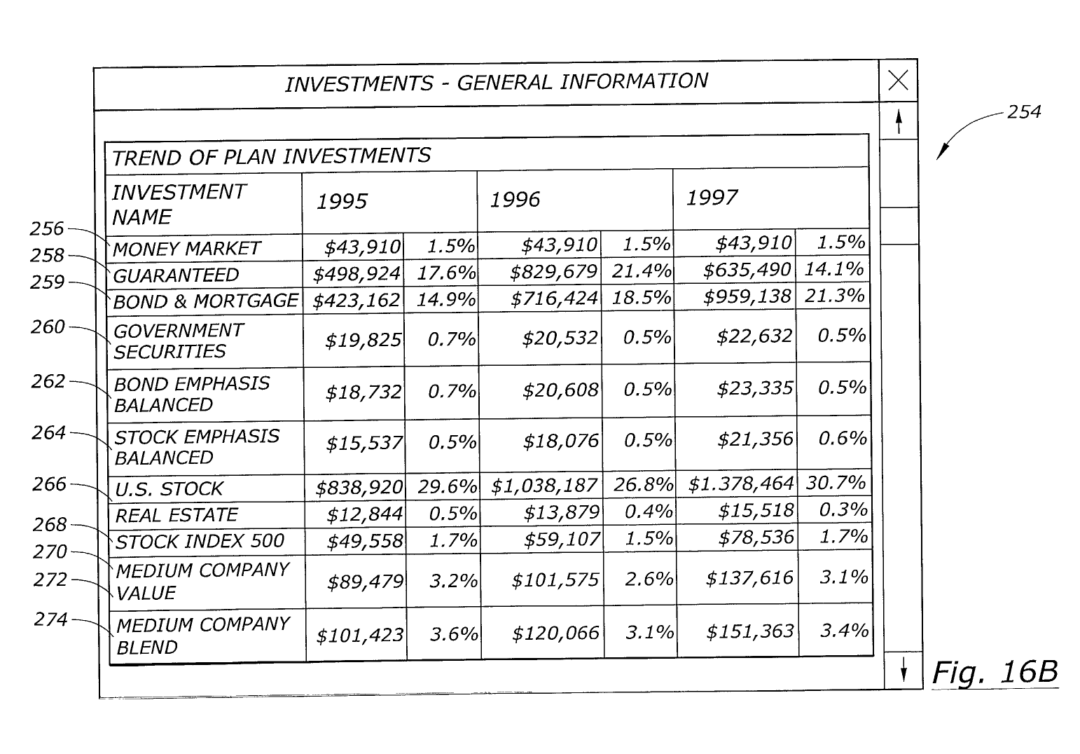

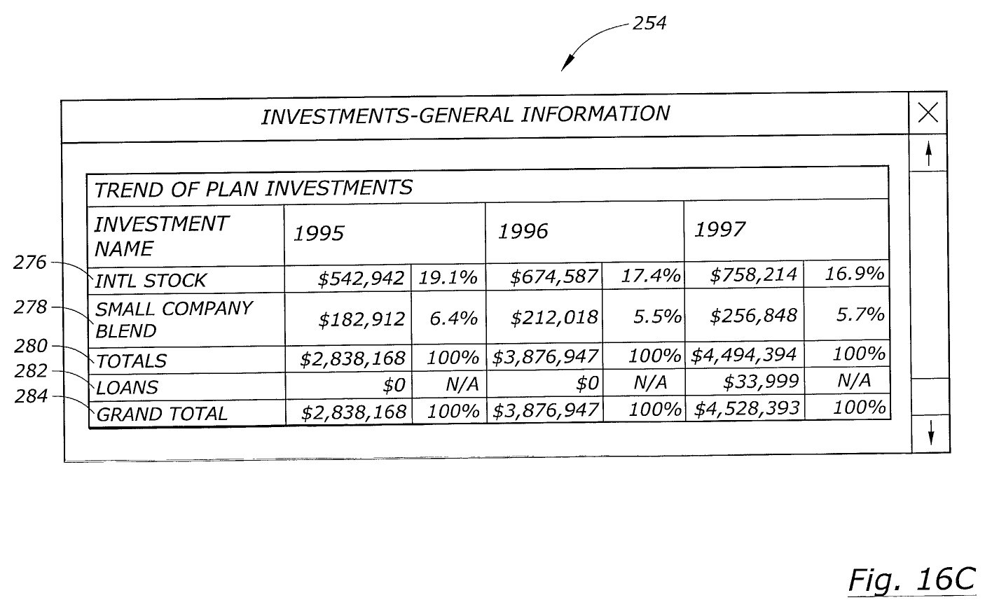

The present invention contemplates that sponsors may be provided with general information concerning investments. FIGS. 16A through C provide examples of types of general information that may be displayed. In FIGS. 16A-C investment general information web page 254 is shown. In FIG. 16A, current investment options are shown along with the risk level associated with those options. For example, a money market account may be considered a conservative option as would a guaranteed interest investment. Bond and mortgage, government securities, bond emphasis balanced, and stock emphasis balanced investments may be considered to carry a moderate level of risk. U.S. stock investments, real estate investments and certain mutual fund investments may be considered to carry a dynamic risk level. Other investment options such as international stock and other mutual funds may be considered to carry an aggressive risk level. The categorization of investments is not required in any way for this invention.

FIG. 16B shows additional information that may be displayed on investment general information web page 254. For example the web page 254 may display trends of plan investments. For example, for money market investments 256, guaranteed interest investments 258, bond and mortgage investments 259, government securities 260, bond emphasis balanced investments 262, stock emphasis balanced investments 264, U.S. stock investments 266, real estate investments 268, stock fund investments 270, 272, and 274. For each investment, the amount of money invested in that investment by the group may be shown along with the corresponding percentage of the total investment.

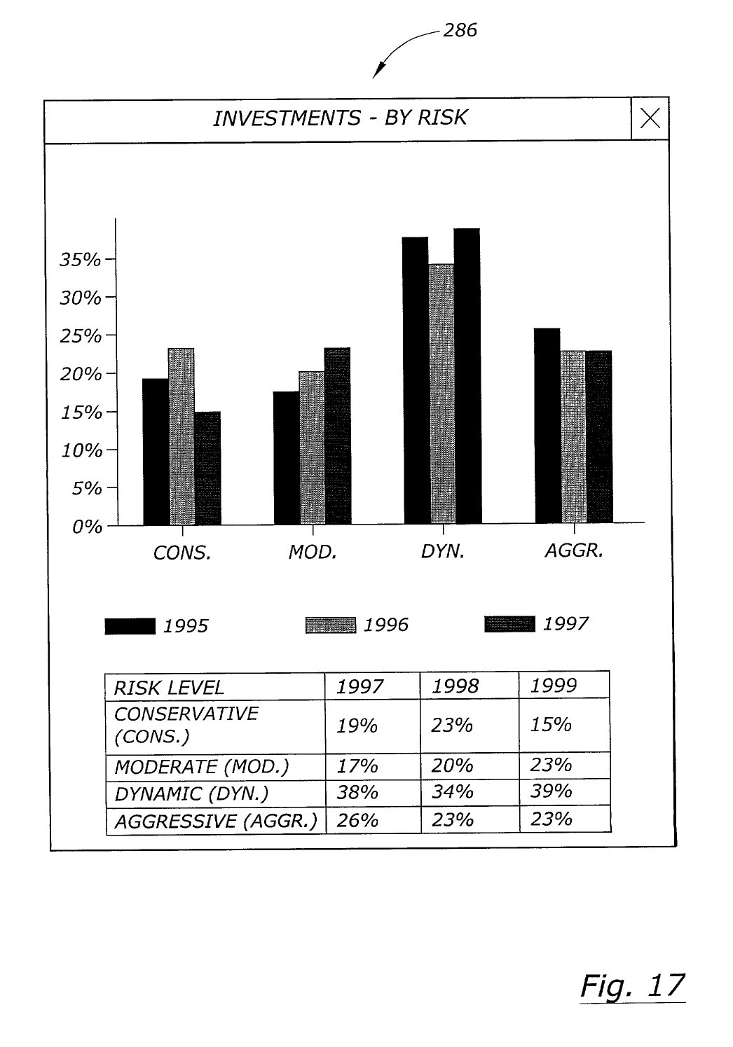

FIG. 17 shows web page 286 which displays summarized investment information by risk. Types of risk may include conservative risk, moderate risk, dynamic risk, and aggressive risk. A bar chart or other graph or chart may display this summarized information. The present invention does not require that the types of risk be shown or categorized in any manner.

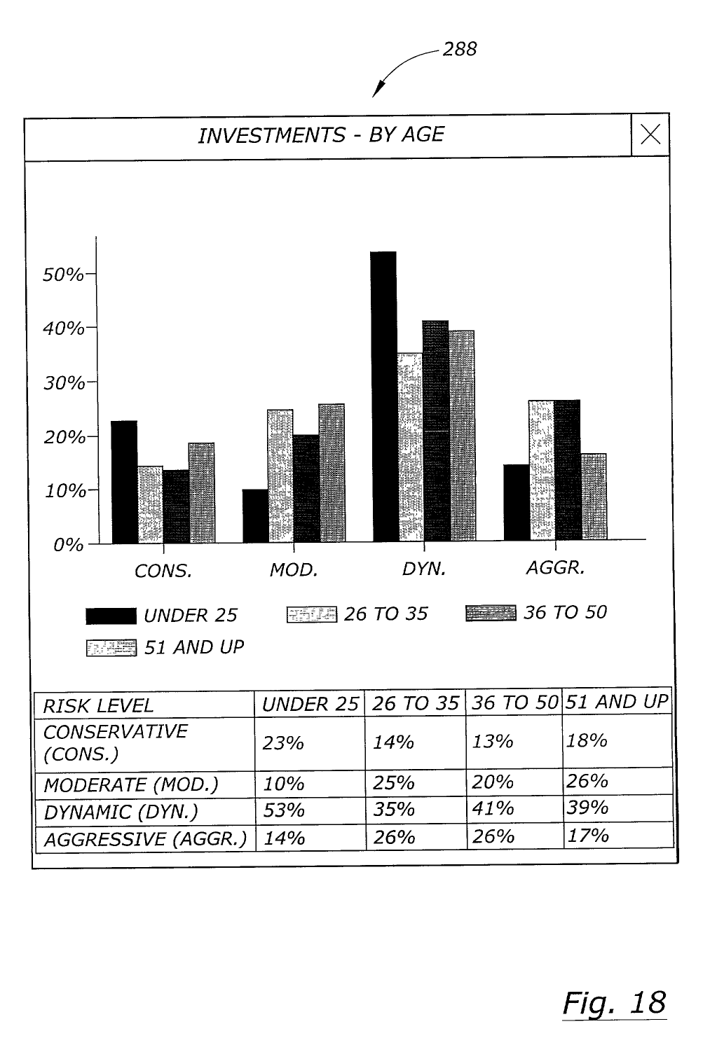

Similarly, FIG. 18 shows investments by age web page 288 that displays investments by age. Investments by age web page 288 contains both a graph such as a bar graph or chart of investment risk and the percent invested and also groups each type of risk by age. This permits a group retirement plan sponsored to determine the type of risk level each age group invests in.

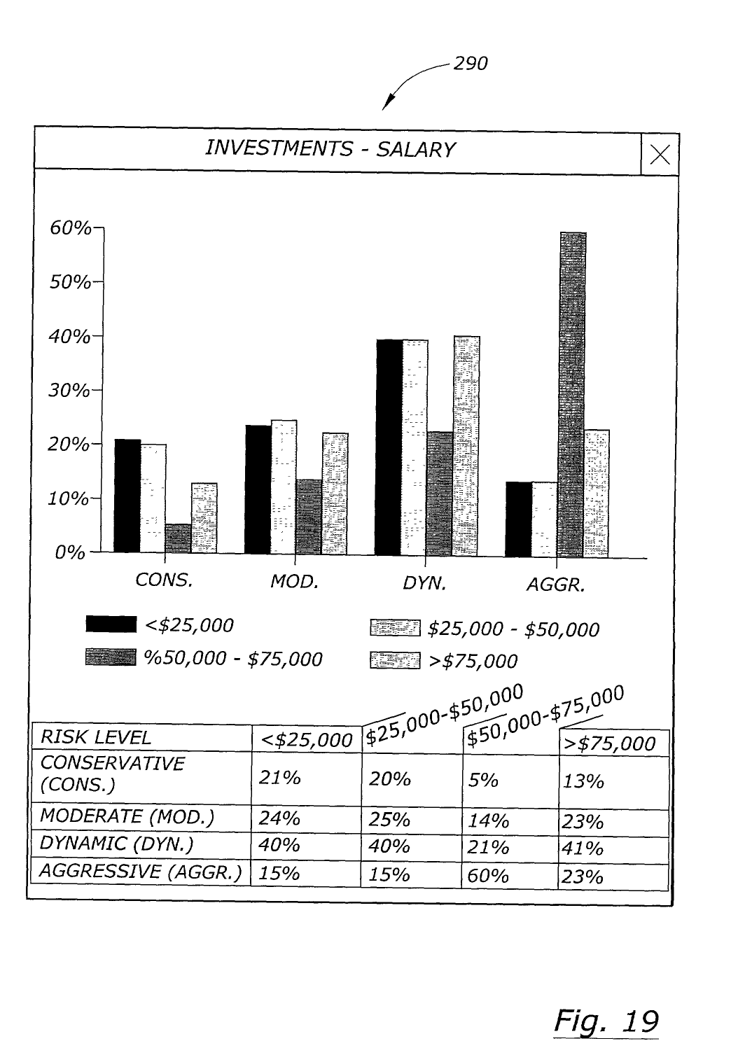

FIG. 19 provides similar summary type information as FIG. 19 shows investment by salary summary web page 290. The risk level associated with each range of salaries is shown in FIG. 19 so that the plan sponsor may view the relationships between the risk level and salary.

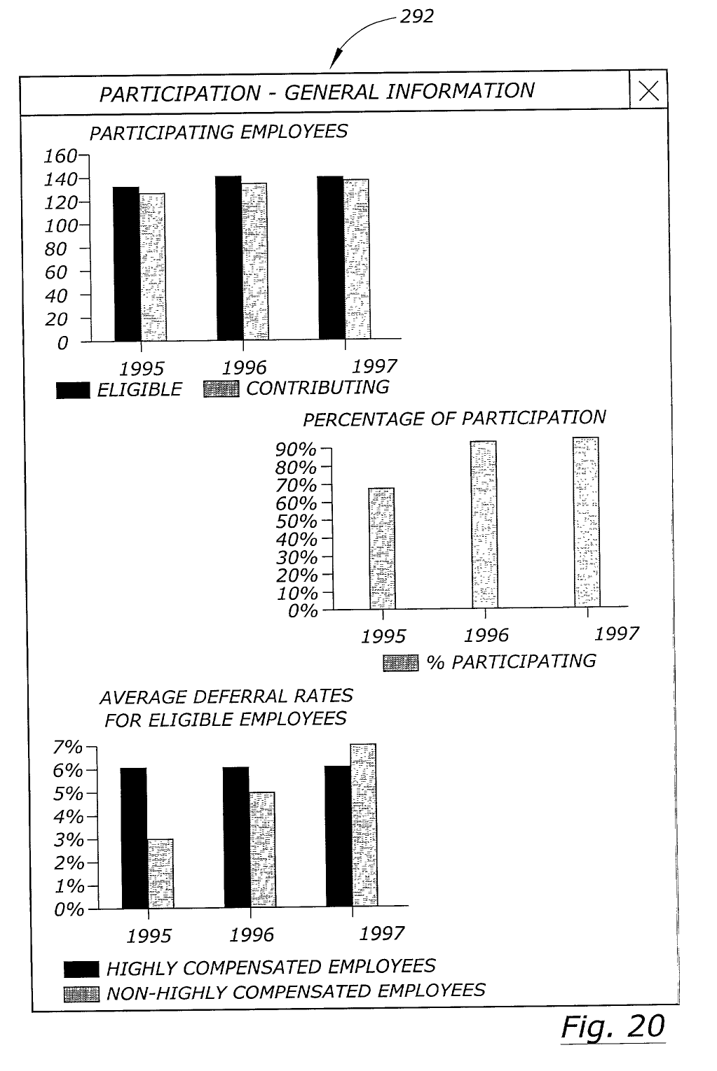

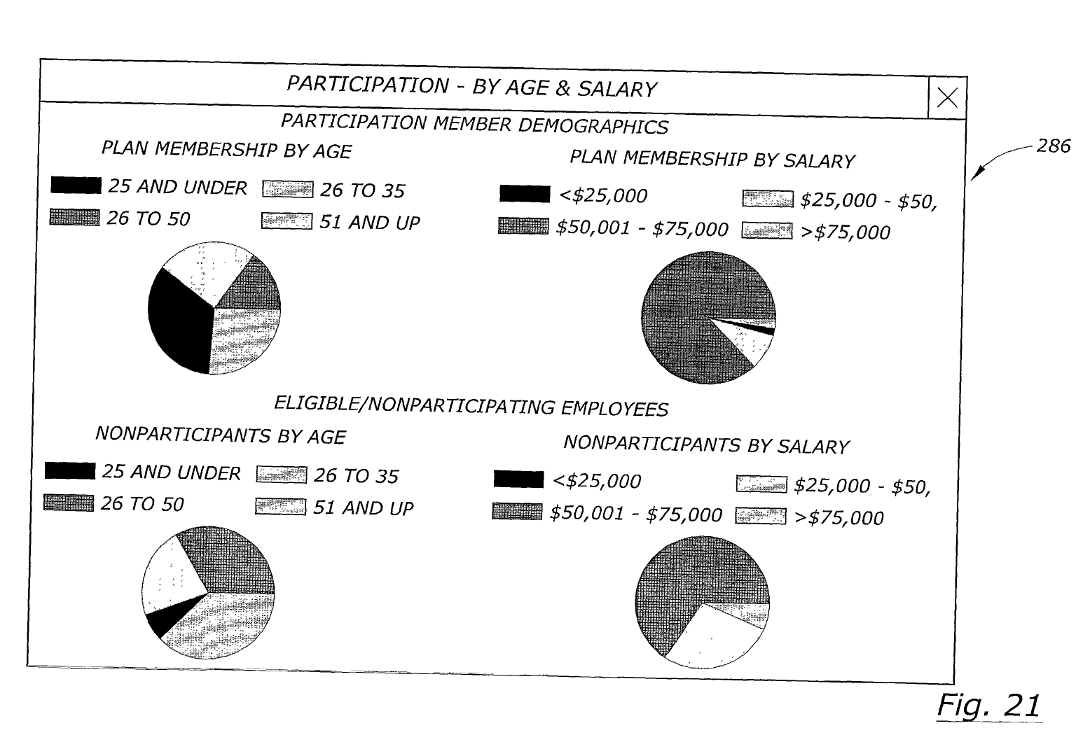

The executive summary information also contains summaries of participation and the group retirement plan. FIG. 20 displays participation general information web page 292. This web page 292 allows the plan sponsor to see the level of participating employees in a retirement plan among those eligible to participate in a plan, the change in participation ranked over time, and the average deferral rates for eligible employees. Similarly, FIG. 21 displays participation by age and salary summary web page 294. Web page 294 provides sponsors with summaries of participation member demographics based on the age of participants or the salary of participants. In addition, web page 294 summarizes eligible but non-participating employees by age and salary. The present invention contemplates numerous other variations in the display of summary information. The present invention contemplates that the summary information can include other types of information that may be useful or desirable to a plan sponsor.

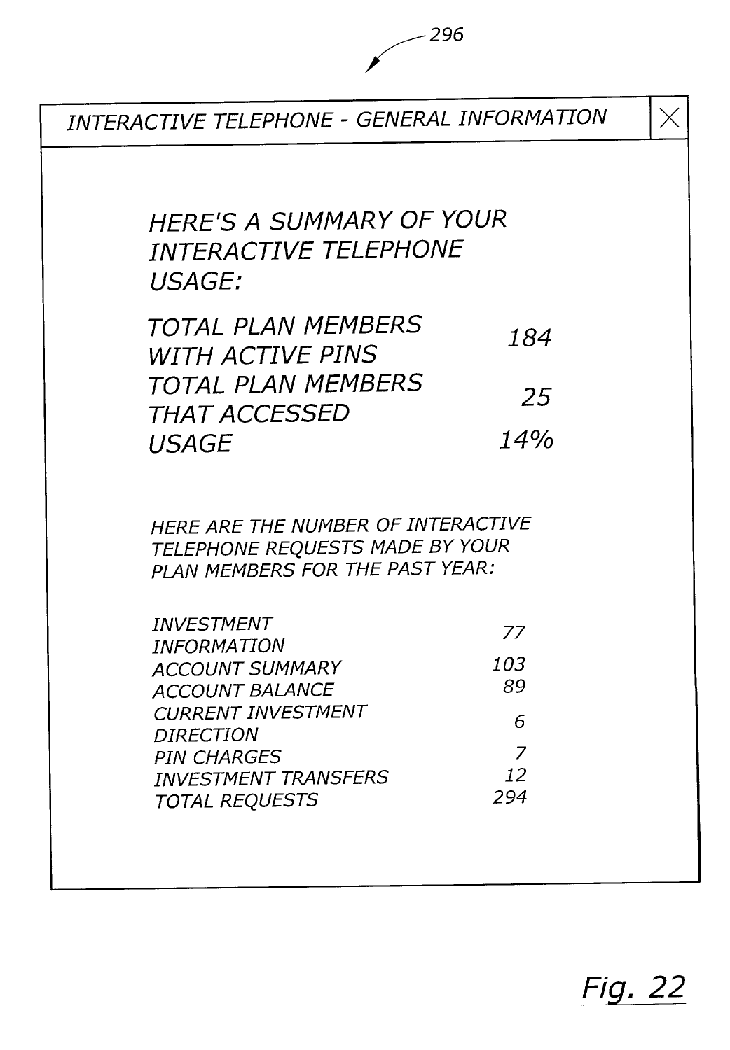

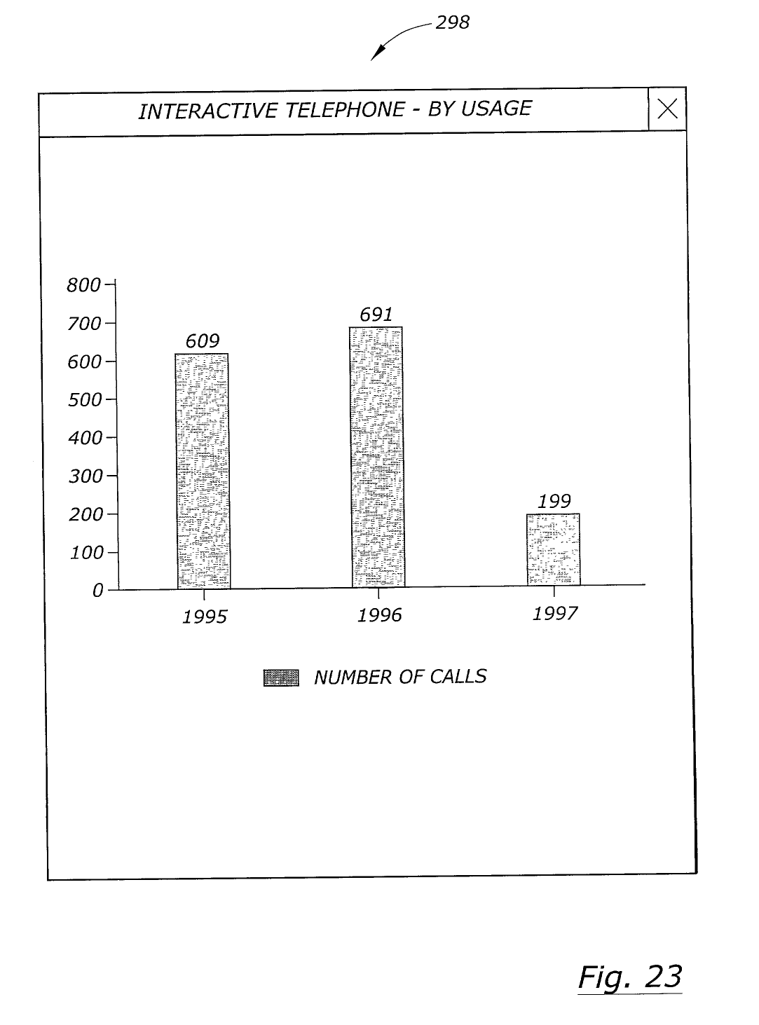

A plan provider may also provide an interactive telephone service that permits group retirement plan participants to call in to request information concerning their retirement accounts using an automated system. FIG. 22 shows interactive telephone general information web page 296. Web page 296 contains a summary of usage of interactive telephone services. This provides a plan sponsor with a summary of the total number of participants with active PINS that potentially could use the system and the total number of plan participants that actually access the system. In addition, the total number requests associated with the interactive telephone service may also be shown. This shows the plan sponsor the type of request made by plan members and the number of requests made. Similarly, FIG. 23 shows interactive telephone by usage summary web page 298.

Communication between group retirement plan sponsors and a group retirement plan provider has now been described. The present invention contemplates numerous variations concerning this communication. In particular, the present invention contemplates that information sent to and received by the plan provider may be in numerous formats and may be displayed in numerous manners. The present invention is in no way limited to a particular formatting or display.

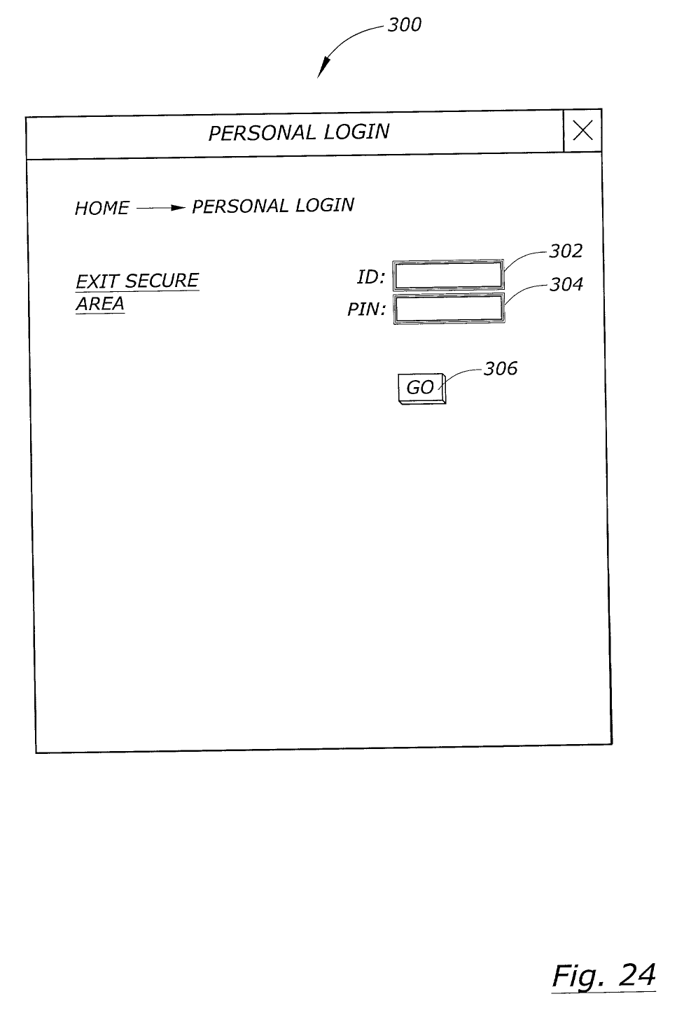

The present invention also permits participants, who may be employees of a particular sponsor, to access their group retirement plan information from a plan provider. In order to access this information, a plan participant logs on to a group retirement plan provider web site. FIG. 24 illustrates the personal log-in web page 300. The plan participant may enter an ID in the text box 302 and a PIN number associated with that ID in PIN text box 304. Then a plan participant may select the go button 306 to log-in. The present invention contemplates that the submission of ID and PIN may be encrypted or otherwise made secure such as is well known in the art. The HTTPS or cther secure protocol may be used, as well as other security techniques or measures such as may be known in the art.

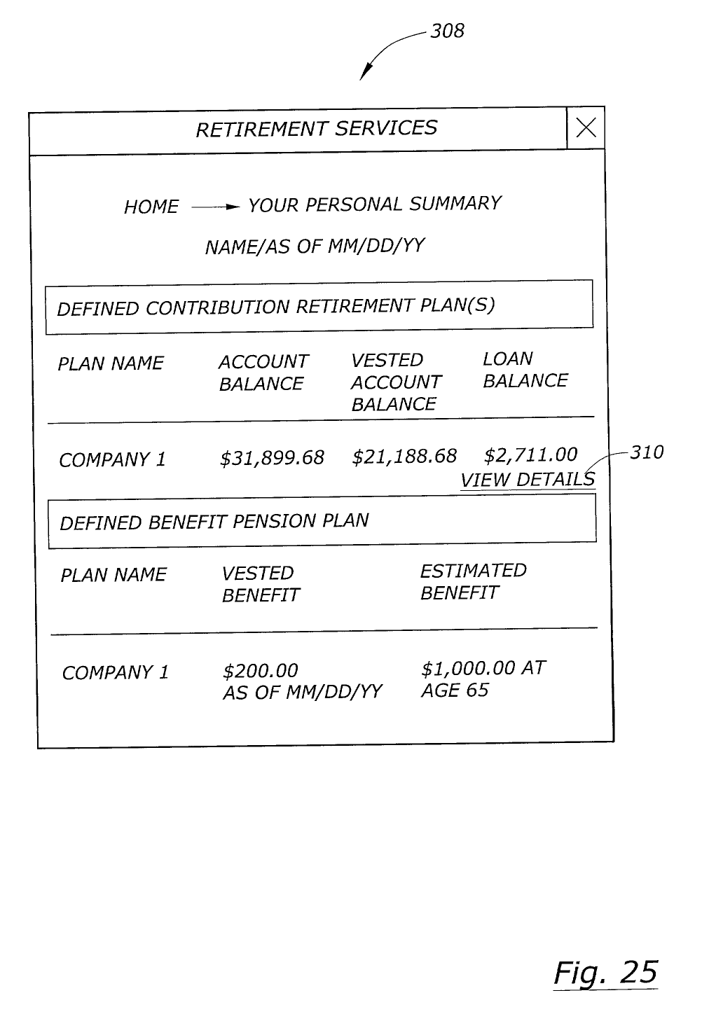

After logging in, the plan participant may be shown a personal summary of retirement plan information such as shown in FIG. 25. FIG. 25 shows a retirement services summary web page 308. The summary web page 308 shows different retirement plans such as contribution retirement plans and defined benefit and pension plans that a particular participant may currently be enrolled in. A particular retirement plan may also provide a link to detailed information such as is shown by view details link 310.

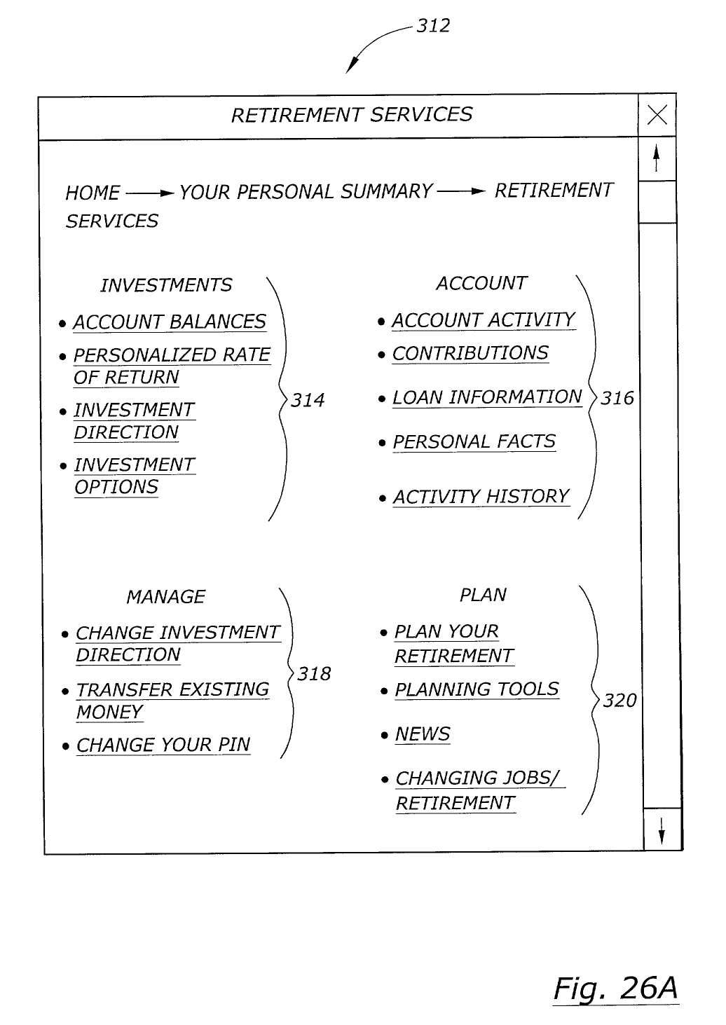

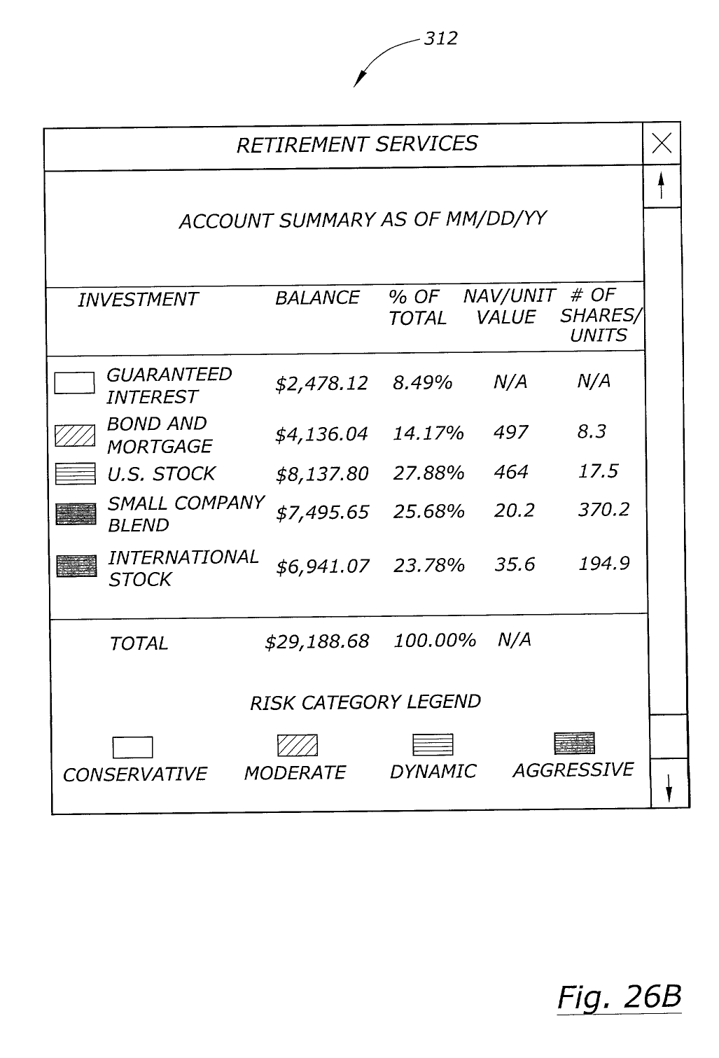

Detailed information concerning the particular individuals' group retirement plan is shown in FIGS. 26A-26B. FIGS. 26A and 26B show the detailed retirement plan summary web page 312. The detailed retirement plan summary web page 312 contains links to information concerning investments 314, account information 316, management actions 318, and planning information 320. This web page 312 also shows an account summary showing the types of investment in which the plan participant invests, the balance of each type of investment, the percent of the total value of a retirement plan invested in a particular investment, the value of units or shares associated with a particular investment where applicable and the number of shares or units associated with a particular investment where applicable.

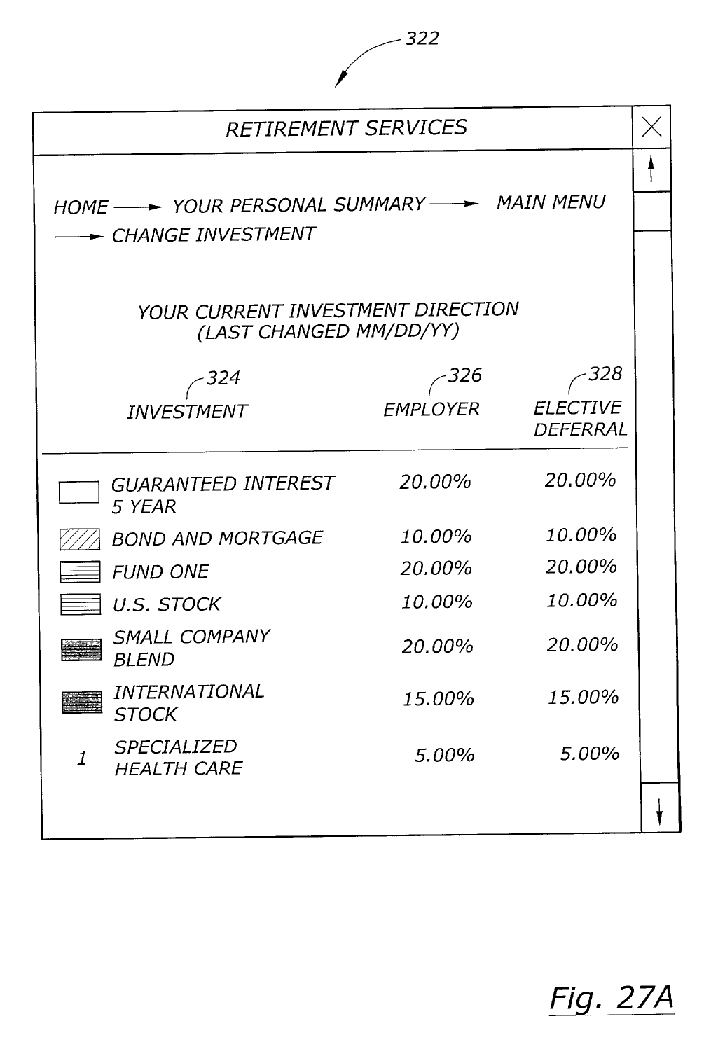

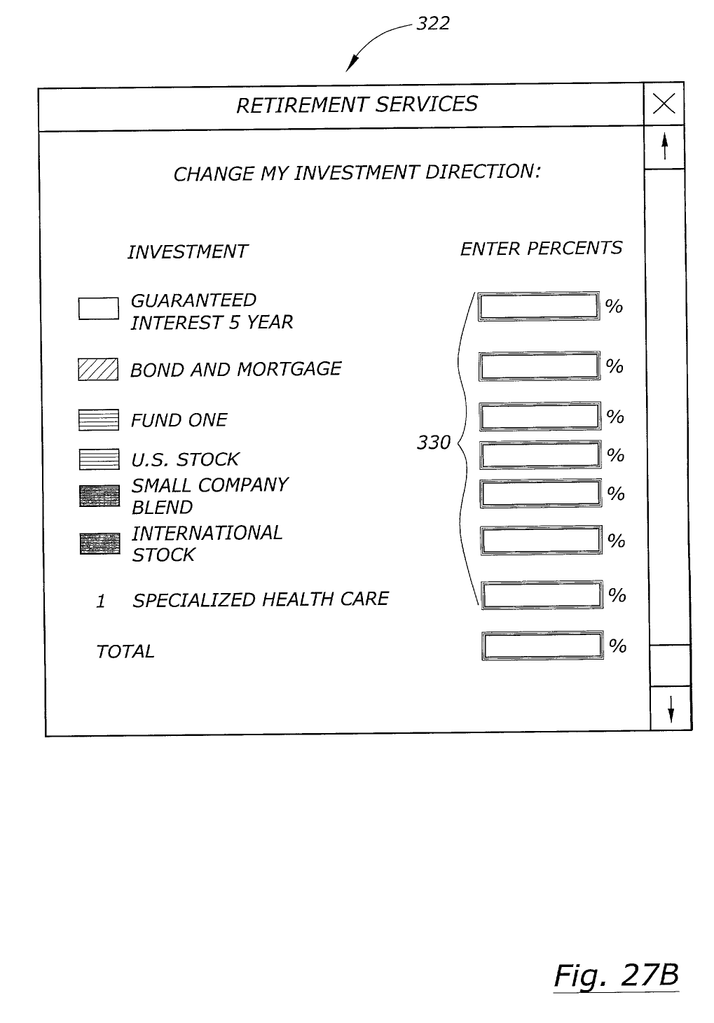

The present invention provides the plan participant not just with information concerning an account but with the ability to update the information and change information such as investment direction, and to transfer existing money from one type of investment to other types of investments. FIGS. 27A and 27B show retirement services change investment web page 322. The change investments web page 322 lists types of investments in column 324, the percentage of employer contributions that should be directed to that particular investment in column 326, and the percentage of elective deferrals that should be directed to that particular investment in column 328. In FIG. 27B, the change investments web page 322 also permits a plan participant to change their investment direction by entering a percentage for each type of investment. Percentage text boxes associated with investments 330 allow a plan participant to enter new percents for each investment type. A total is also shown, the total being 100%.

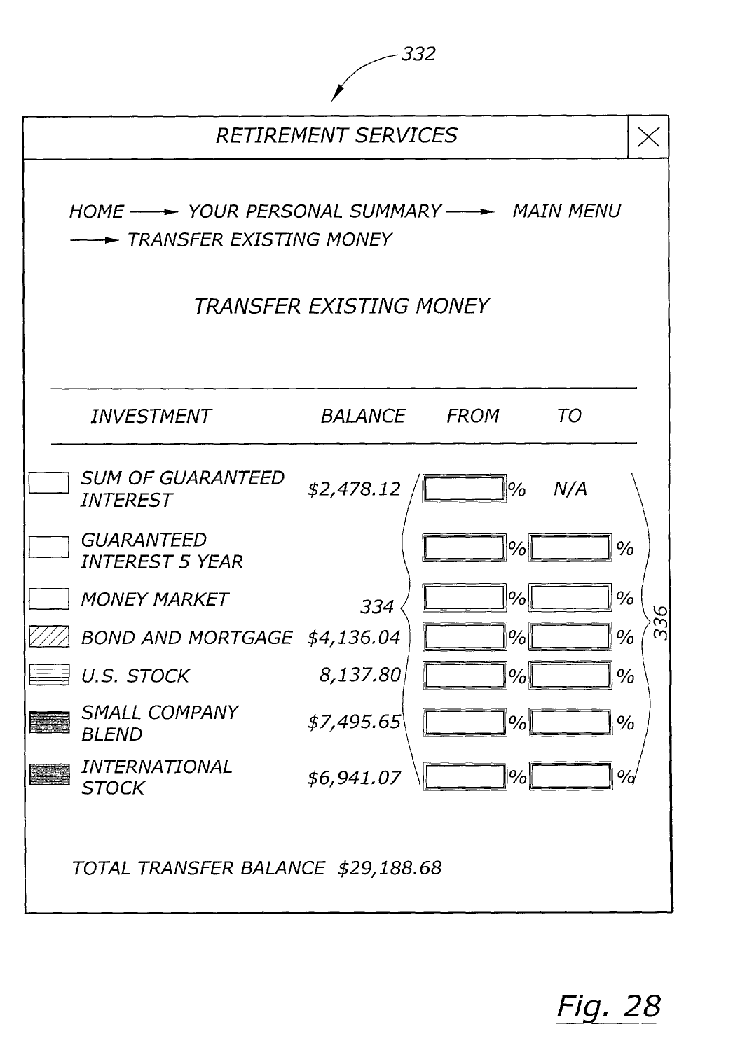

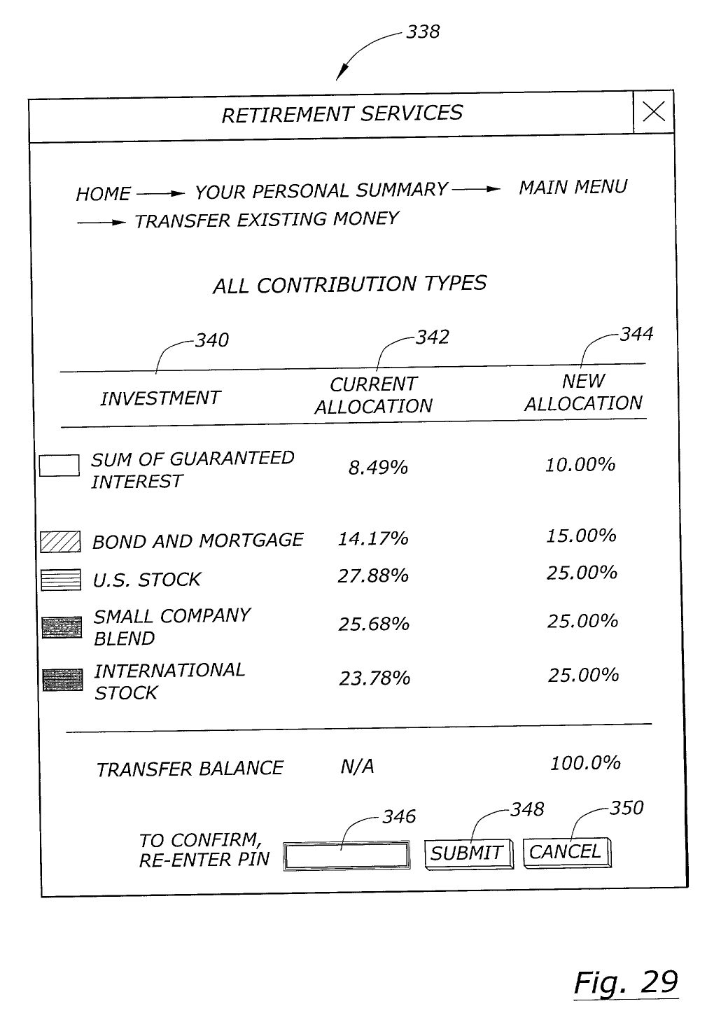

In addition to changing investment direction, a plan participant may transfer existing money from one type of investment to a second type of investment. FIG. 28 depicts the transfer existing money web page 332. In transfer existing money web page 332 a plan participant is provided with the types of investments, the balance for each type of investment, and the option to change from a particular percentage of the total balance in a retirement account to a new percentage of the total balance in the retirement account. In this manner, percent values in the “from” columns 334 may be changed to different percent values in the “to” columns 336.

The present invention also contemplates that the transfer of existing money may be by dollar amounts as well as percentage values. In addition, this transfer of money may be by money type. For example, by plan participant deferral or by sponsor matching.

The present invention also permits a retirement plan participant to rebalance money. A rebalance of money in a retirement account may be appropriate where a plan participant has invested in a number of different types of investments and is contributing a particular percentage value to each investment. Then, due to market fluctuations or shifts, the amount of the total value of the retirement account is not related to the amount of the percentage originally allocated to a particular type of investment. In this situation, a group retirement plan participant may desire to rebalance money in their account to change the percentage of the retirement account balance from a current allocation to a new allocation. The rebalance web page 338 includes an investment column 340, a current allocation column 342, and a new allocation column 344 that show for each investment, the current allocation and the new allocation. The plan participant may then confirm the rebalance action by re-entering their PIN number in text box 346 for security purposes. The retirement plan participant may then submit the rebalance changes to the group retirement plan provider by selecting the submit button 348 or may cancel the rebalance action by selecting the cancel button 350. The plan participant may also schedule the rebalance transaction to occur quarterly.

The information flow of the present invention has been described in detail by showing the types of information exchanged between group retirement plan providers and sponsors, and between group retirement plan providers and participants. In the embodiment described, this information is exchanged through use of an Internet web site. In addition, there is information flow related to the group retirement plan provider.

Based on the disclosed information flow, one skilled in the art can appreciate that there are many different variations in which the invention can be realized. In particular, it is to be appreciated that validation of the information can occur at various stages in the process, including by applets running on the client PC, programs running on the web server, and by the mainframe. It is also to be appreciated that once the information received from a plan participant or plan sponsor is in the system and validated, the plan provider may act upon that information. For example, once a plan participant sends information concerning modifications to the plan participant's investments, the plan provider's system may act accordingly by performing electronic securities transactions or other actions that a plan provider may typically perform once it receives information from plan participants or plan providers.

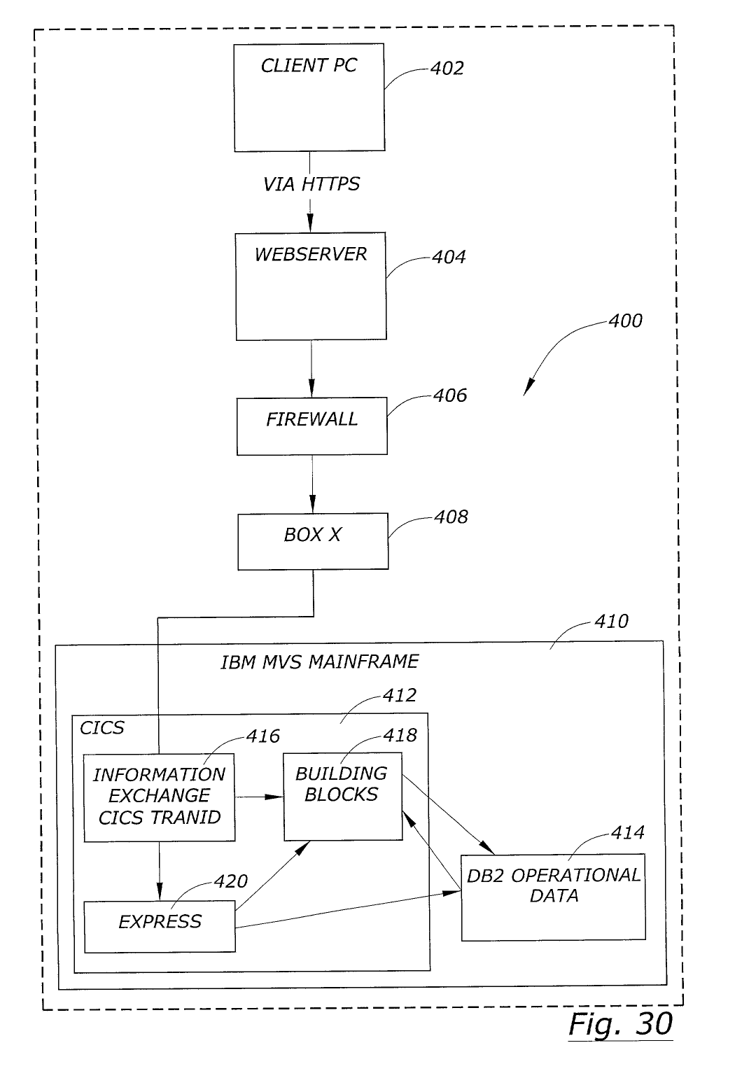

The system of the group retirement plan provider is shown in FIG. 30. In FIG. 30 a client PC 402 such as may be used by a group retirement plan participant or a group retirement plan sponsor is shown. The client PC 402 communicates with a web server 404 associated with the group retirement plan provider. The group retirement plan provider's web server 404 communicates with the plan provider's internal systems. To protect the plan provider's internal data, a firewall 406 is used. Box X 408 can be a device that filters and directs traffic to and from mainframe 410. The mainframe 410 is capable of reading and writing to database 414.

The client PC 402 may be a personal computer using a Microsoft Windows operating system. Client PC 402 may use an internet browser such as Microsoft Internet Explorer or Netscape Navigator. The web browser used by client PC 402 is may be capable of viewing hypertext markup language (HTML) and capable of executing JAVA applets. In addition, the web browser used by client PC 402 may be capable of communicating using a secure HTTP protocol (HTTPS).

The web server 404 may operate under a UNIX operating system. The web server is capable of running one or more common gateway interface (CGI) programs associated with the system. The CGI programs may be written in any number of computer languages, including C++. The CGI programs may be used to connect to the mainframe 410 for data retrieval and data validation purposes. The CGI programs may also serve the HTML pages with embedded JAVA applets.

The firewall 406 may be any number of commercially available firewall products. The firewall is used to protect against unauthorized access to the mainframe 410.

Box X 408 is not essential for operation of the present invention but may be used because the web site for the service provider may have many different functions and applications and serves many different business units, including some of which are not related to the present invention. For example, a service provider may also provide record keeping and other services relating to pensions, banking, brokerage services, and other services. When this is the case, incoming communications need to be directed to the correct business unit. This can be accomplished by using a communications protocol where each business unit or application has a header associated with it. Data streams are then identified by the inclusion of the header information so that box X 408 can direct the information to the proper server or mainframe.

The mainframe 410 may be an IBM MVS mainframe computer. The mainframe 410 runs a Customer Information Control System (CICS) shared operating environment. Within the CICS environment, a transaction name (tranid) is associated with the task of performing an information exchange. A COBOL program may be invoked to interpret the request. The COBOL program is used to perform retrieval from the operational data storage and to perform business rule validation of the data.

The COBOL programs may use IBM's MQSeries Queue or other products to communicate between various COBOL applications running on the mainframe. This type of product enables applications to communicate regardless of the operating system or network on which the applications are running. The originating application (the Information Exchange application) communicates with an express application by sending a message to a queue. The recipient application (the Express application) retrieves the message from the queue.

The Express application 420 may also be a COBOL program. The express application is a workflow system. After the request has been validated the Express application 420 is invoked. The Express application 420 initiates processing of the request into the operational data storage in order to speed the request process.

The Building Blocks programs 418 may be COBOL programs used to perform data retrieval from the operational data storage and to perform business rule data validation. The Building Blocks programs communicate with the DB2 operational data 414. DB2 is an IBM database product. The DB2 operational data 14 may contain information related to a plan provider, a plan sponsor, or a plan participant. In this manner, information and information requests originating at the client PC 402 may be used to update or retrieve data from the database 414.

The present invention is in no way limited to the particular types of computers, types of software, or specific implementation described. Numerous types of middleware software can be used when the web server communicates with a mainframe computer. The present invention also contemplates, that mainframe 410, box X 408, and firewall 406 are not essential as the web server may be able to directly access a database containing group retirement plan information.

A method and system for group retirement plan administration has been described that provides advantages to providers, sponsors, and participants. The present invention contemplates numerous variations in the format and display of information, and the implementation of the invention, including the selection of particular hardware and software products used to implement the invention.

What is claimed is:

1. A method of providing group retirement plan administration to one or more sponsors, at least one sponsor having one or more participants enrolled in a retirement plan, the method comprising:
electronically receiving contribution information from a sponsor;
automatically updating a provider database based on the contribution information received from a sponsor;
electronically providing account information to at least one sponsor; and
electronically providing account information to at least one participant.

2. The method of claim 1 further comprising the step of electronically transferring funds between at least one account associated with a sponsor and at least one account associated with a provider.

3. The method of claim 1 wherein the step of electronically receiving contribution information from the sponsor is electronically receiving contribution information from the sponsor over a computer network.

4. The method of claim 3 wherein the step of electronically receiving contribution information from the sponsor is electronically receiving contribution information from the sponsor over the Internet.

5. The method of claim 1 wherein the step of electronically providing account summary information to at least one sponsor is electronically providing account summary information to at least one sponsor over a computer network.

6. The method of claim 5 wherein the step of electronically providing account summary information to at least one sponsor is electronically providing account summary information to at least one sponsor over the Internet.

7. The method of claim 1 wherein the step of electronically providing account summary information to participants is electronically providing account summary information to participants over a computer network.

8. The method of claim 7 wherein the step of electronically providing account summary information to participants is electronically providing account summary information to participants over the Internet.

9. The method of providing group retirement plan administration of claim 1 further comprising electronically receiving investment allocation information from a participant.

10. The method of claim 9 further comprising automatically updating a provider database based on the investment allocation information received from the participant.

11. The method of claim 10 further comprising performing an electronic financial securities transaction based on the investment allocation information received from the participant.

12. The method of claim 1 wherein the step of electronically providing account information to sponsors is electronically providing compliance data collection to sponsors.

13. The method of claim 1 wherein the step of electronically providing account information to sponsors is electronically providing electronic fund transfer options to sponsors.

14. The method of claim 1 wherein the step of electronically providing account information to at least one sponsor is electronically providing a record of the sponsor's recent activities to the sponsor.

15. The method of claim 1 wherein the step of electronically providing account information to at least one sponsor is electronically providing a summary of investments associated with the sponsor's group retirement plan to the sponsor.

16. The method of claim 1 wherein the step of electronically providing account information to at least one sponsor is electronically providing a summary of the participation of employees of the sponsor within a group retirement plan to the sponsor.

17. The method of claim 1 wherein the step of electronically providing account information to participants is electronically providing account balance information to participants.

18. The method of claim 1 wherein the step of electronically providing account information to participants is electronically providing personalized rate of return information to participants.

19. The method of claim 1 wherein the step of electronically providing account information to participants is electronically providing investment direction information to participants.

20. The method of claim 1 wherein the step of electronically providing account information to participants is electronically providing investment options information to participants.

21. The method of claim 1 wherein the step of electronically providing account information to participants is electronically providing account activity information to participants.

22. The method of claim 1 wherein the step of electronically providing account information to participants is electronically providing activity history information to participants.

23. A method of providing group retirement plan administration to one or more sponsors, at least one sponsor having one or more participants enrolled in a retirement plan, the method comprising:
electronically receiving contribution information from a sponsor;
automatically updating a provider database based on the contribution information received from the sponsor;
electronically transferring funds between at least one account associated with a sponsor and at least one account associated with a provider;
electronically receiving investment allocation information from a participant; and
automatically updating a provider database based on the investment allocation information received from the participant.

24. The method of claim 23 wherein the step of electronically receiving contribution information from the sponsor is electronically receiving contribution information from the sponsor over a computer network.

25. The method of claim 24 wherein the step of electronically receiving contribution information from the sponsor is electronically receiving contribution information from the sponsor over the Internet.

26. The method of claim 23 further comprising performing an electronic financial securities transaction based on the investment allocation information received from the participant.

27. A group retirement plan administration system for permitting a provider to administer at least one group retirement plan for at least one sponsor, and at least one participant associated with at least one of the group retirement plans, the system comprising:
a provider group retirement plan database for storing information associated with at least one group retirement plan; and
a provider web server capable of exchanging information with the provider group retirement plan database, the web server providing secured access to at least one sponsor, and the web sever providing secured access to at least one participant associated with a group retirement plan.

28. The group retirement plan administration system of claim 27 further comprising a firewall between the provider web server and the provider group retirement plan database for protecting the group retirement plan database from intrusion.

29. The group retirement plan administration system of claim 27 further comprising a mainframe computer, the provider group retirement plan database stored in physical memory accessible by the mainframe computer, the provider web server capable of requesting information from the database, and the provider web server capable of sending information to the database.

30. A group retirement plan administration system for permitting a provider to administer at least one group retirement plan for at least one sponsor, and at least one participant associated with at least one of the group retirement plans, the system comprising:
means for electronically storing information associated with group retirement plan sponsors;
means for electronically storing information associated with group retirement plan participants;
means for electronically sending retirement plan contribution information from the group retirement plan sponsors to the provider;
means for electronically communicating retirement plan information from the group retirement plan sponsor to the group retirement plan participants; and
means for electronically communicating account information from the group retirement plan participants to the group retirement plan sponsor.
